(19) United States
(12) Patent Application Publication
(10) Pub. No.: US 2019/0039377 A1
(43) Pub. Date: Feb. 7, 2019

(54) INKJET PRINTER

(71) Applicant: Roland DG Corporation, Hamamatsu-shi (JP)

(72) Inventors: Hiroshi OKUNO, Hamamatsu-shi (JP); Teppei SAWADA, Hamamatsu-shi (JP); Naoki UEDA, Hamamatsu-shi (JP); Yuichi SUGIYAMA, Hamamatsu-shi (JP); Youichirou OGAWA, Hamamatsu-shi (JP)

(21) Appl. No.: 16/051,750

(22) Filed: Aug. 1, 2018

(30) Foreign Application Priority Data
Aug. 2, 2017 (JP) 2017-150155
Aug. 2, 2017 (JP) 2017-150156
Jun. 5, 2018 (JP) 2018-107667
Jun. 5, 2018 (JP) 2018-107668

(51) Int. Cl. B41J 2/165

(52) U.S. Cl. CPC B41J 2/16505; B41J 2002/16555; B41J 2/16579; B41J 2/16523

(57) ABSTRACT

A printer includes ink heads, an ink head conveyor, a movable table, cap valves, lifters, a guide device, and a controller. The conveyor moves the ink heads in a main scanning direction. The movable table includes caps and is movable in the main scanning direction by the conveyor. The guide device defines a path along which the movable table is movable between a cap attaching position, a valve opening position, and a retracted position. Movement of the movable table to the valve opening position causes the lifters to abut against the cap valves to bring the cap valves to an open state and expose opening/closing passages to the atmosphere. Movement of the movable table to the cap attaching position from the valve opening position causes the lifters to move away from the cap valves to bring the cap valves to a closed state.

### CROSS REFERENCE TO RELATED APPLICATIONS

This application claims the benefit of priority to Japanese Patent Application No. 2017-150155 filed on Aug. 2, 2017, Japanese Patent Application No. 2017-150156 filed on Aug. 2, 2017, Japanese Patent Application No. 2018-107667 filed on Jun. 5, 2018 and Japanese Patent Application No. 2018-107668 filed on Jun. 5, 2018. The entire contents of these applications are hereby incorporated herein by reference.

### BACKGROUND OF THE INVENTION

### 1. Field of the Invention

The present invention relates to inkjet printers.

### 2. Description of the Related Art

An inkjet printer known in the related art includes an ink head provided at its nozzle surface with a plurality of nozzles and effects predetermined printing on a recording medium in an inkjet mode. Such an inkjet printer is provided with a cap unit in order to maintain discharge performance of the nozzles at a suitable level. The cap unit includes a cap to cover the nozzle surface when no printing is being effected.

The cap unit covers the nozzle surface with the cap so as to define an enclosed space between the nozzle surface and the cap. This reduces or prevents volatilization of ink. The cap unit may include a suction pump connected to the cap. In such a case, the suction pump is driven, with the enclosed space defined, so that ink remaining in the nozzles is forcedly discharged to the cap. This prevents ink from solidifying in the nozzles and thus precludes clogging of the nozzles. A suction operation to discharge ink remaining in the ink head in this manner is generally referred to as “main suction”.

After main suction, the suction pump is driven again, with the enclosed space exposed to atmospheric pressure, in order to discharge ink remaining in the cap unit, such as ink remaining in the cap or suction path. This makes it possible to discharge ink remaining in the cap unit without applying any excessive negative pressure to the ink head. A suction operation to discharge ink in the cap unit is generally referred to as “idle suction”. A combination of main suction and idle suction may be referred to as “suction cleaning”. JP 2016-87858 A, for example, discloses a technique involving performing idle suction, with the cap detached from the nozzle surface, or performing idle suction after the enclosed space is exposed to atmospheric pressure through an atmospheric pressure exposure element, with the cap in intimate contact with the nozzle surface.

A printer includes an ink head and a cap for each color of ink. Thus, a printer that uses various types of ink includes a plurality of ink heads and a plurality of caps. Such a printer requires an atmospheric pressure exposure element for each of the caps in order to expose enclosed spaces to atmospheric pressure, with the caps kept in intimate contact with nozzle surfaces, during idle suction. Suction cleaning for ink heads, however, is desirably performed easily with the simplest structure possible.

### SUMMARY OF THE INVENTION

Accordingly, preferred embodiments of the present invention provide inkjet printers that each enable, with an uncomplicated structure, exposure of the inside of caps to atmospheric pressure in a simple manner, with the caps kept in intimate contact with ink heads.

A preferred embodiment of the present invention provides an inkjet printer including an ink head, an ink head conveyor, a movable table, a cap valve, a valve opener, a guide device, and a controller. The ink head includes a nozzle surface provided with a nozzle to discharge ink. The ink head conveyor moves the ink head in a main scanning direction. The main scanning direction includes a first direction and a second direction opposite to the first direction. The movable table includes a cap attachable to the ink head so as to cover the nozzle surface. The movable table is movable in the main scanning direction by the ink head conveyor. The cap valve is connected to the cap through a first passage. The cap valve is structured to open and close the first passage. The valve opener is structured to open the cap valve. The guide device defines a path along which the movable table is movable between a cap attaching position, a valve opening position, and a retracted position. The cap attaching position is a position where the cap is attached to the ink head. The valve opening position is located in the first direction relative to the cap attaching position. The valve opening position is a position where the cap valve abuts against the valve opener. The retracted position is located in the second direction relative to the cap attaching position. The retracted position is a position where the cap is detached from the ink head. Movement of the movable table to the valve opening position causes the valve opener to abut against the cap valve so as to bring the cap valve to an open state and expose the first passage to atmosphere. Movement of the movable table to the cap attaching position from the valve opening position causes the valve opener to move away from the cap valve so as to bring the cap valve to a closed state.

The atmospheric pressure exposure element disclosed in JP 2016-87858 A includes a rotational valve element. Rotating the rotational valve element enables opening and closing of an atmosphere communication hole. The rotation of the rotational valve element additionally requires a control mechanism to electrically or magnetically produce an actuating force. In contrast to this, the inkjet printer according to the present preferred embodiment uses, instead of such an additional control mechanism, an arrangement to attach the cap to the ink head. Thus, merely providing the valve opener enables opening and closing of the cap valve with a simple dynamic operation. Consequently, the present preferred embodiment provides an inkjet printer that enables, with an uncomplicated structure, exposure of the inside of the cap to atmospheric pressure in a simple manner, with the cap kept in intimate contact with the ink head. If the inkjet printer includes a plurality of ink heads, the present preferred embodiment would enable a plurality of cap valves to simultaneously open or close with an uncomplicated structure and a simple operation.

Thus, various preferred embodiments of the present invention provide inkjet printers that each enable, with an uncomplicated structure, exposure of the inside of caps to atmospheric pressure in a simple manner, with the caps kept in intimate contact with ink heads. Various preferred embodiments of the present invention make it possible to equalize the pressure inside enclosed spaces and the pressure inside ink heads after end of main suction so as to suitably prevent backflow of a fluid during idle suction and suitably perform suction cleaning.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an inkjet printer according to a preferred embodiment of the present invention, with the inkjet printer partially cut out.

FIG. 2 is a front view of a cap unit according to a preferred embodiment of the present invention.

FIG. 3 is a bottom view of an ink head according to a preferred embodiment of the present invention.

FIG. 4 is a schematic diagram illustrating ink discharge paths according to a preferred embodiment of the present invention.

FIG. 5 is a partial perspective view of the cap unit according to a preferred embodiment of the present invention.

FIG. 6 is a cross-sectional view of a cap according to a preferred embodiment of the present invention, illustrating the structure of the cap.

FIG. 7A is a front view of main components of the cap unit located at a standby position.

FIG. 7B is a front view of the main components of the cap unit located at a cap attaching position.

FIG. 7C is a front view of the main components of the cap unit located at a valve opening position.

FIG. 8 is a block diagram illustrating the configuration of a controller according to a preferred embodiment of the present invention.

FIG. 9 is a flow chart illustrating the procedure of suction cleaning according to a preferred embodiment of the present invention.

FIG. 10 is a front view of a composite cap valve according to a preferred embodiment of the present invention, illustrating the closed state of the composite cap valve.

FIG. 11A is a cross-sectional view of the cap valve according to a preferred embodiment of the present invention, illustrating the open state of the cap valve.

FIG. 11B is a cross-sectional view of the cap valve according to a preferred embodiment of the present invention, illustrating the closed state of the cap valve.

FIG. 12 is a perspective view of lifters of a guide device according to a preferred embodiment of the present invention, illustrating the structure of each lifter.

### DETAILED DESCRIPTION OF THE PREFERRED EMBODIMENTS

Inkjet printers according to preferred embodiments of the present invention will be described below with reference to the drawings. The preferred embodiments described below are naturally not intended to limit the present invention in any way. Components or elements having the same functions are identified by the same reference signs, and description thereof will be omitted or simplified if deemed redundant.

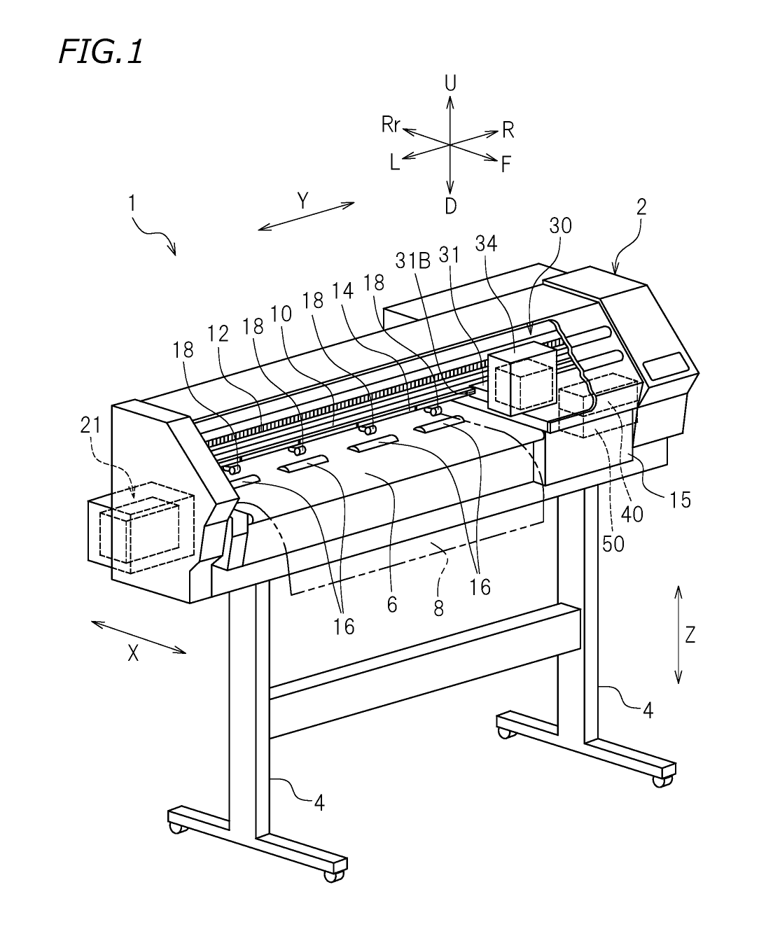

FIG. 1 is a perspective view of an inkjet printer 1 according to the present preferred embodiment. The inkjet printer 1 will hereinafter be referred to as a “printer 1”. The printer 1 effects printing in an inkjet mode. As used herein, the term “inkjet mode” refers to an inkjet mode that involves techniques including various continuous methods, such as a binary deflection method and a continuous deflection method, and various on-demand methods, such as a thermal method and a piezoelectric method. In the following description, the reference signs F, Rr, R, L, U, and D in the drawings respectively represent front, rear, right, left, up, and down with respect to a user facing the front of the printer 1. The reference signs F, Rr, R, L, U, and D in the drawings may respectively represent a front side, a rear side, a right side, a left side, an upper side, and a lower side. The reference signs F, Rr, R, L, U, and D in the drawings may respectively represent a forward direction, a rearward direction, a rightward direction, a leftward direction, an upward direction, and a downward direction. The reference sign Y in the drawings represents a main scanning direction. In the present preferred embodiment, the main scanning direction Y is a right-left direction. The main scanning direction Y includes the rightward direction R and the leftward direction L. The rightward direction R corresponds to a first direction Y1. The leftward direction L corresponds to a second direction Y2. The main scanning direction Y is a direction in which an ink head unit 30 (which will be described below) moves. The reference sign X in the drawings represents a sub-scanning direction. The sub-scanning direction X corresponds to a direction in which a recording medium 8 is to be conveyed. The sub-scanning direction X is a direction intersecting the main scanning direction Y. In one example, the sub-scanning direction X intersects the main scanning direction Y at right angles in a plan view. In the present preferred embodiment, the sub-scanning direction X is a front-rear direction. The reference sign Z in the drawings represents a height direction. In the present preferred embodiment, the height direction Z is an up-down direction. These directions are defined merely for the sake of convenience of description and do not limit in any way how the printer 1 may be installed.

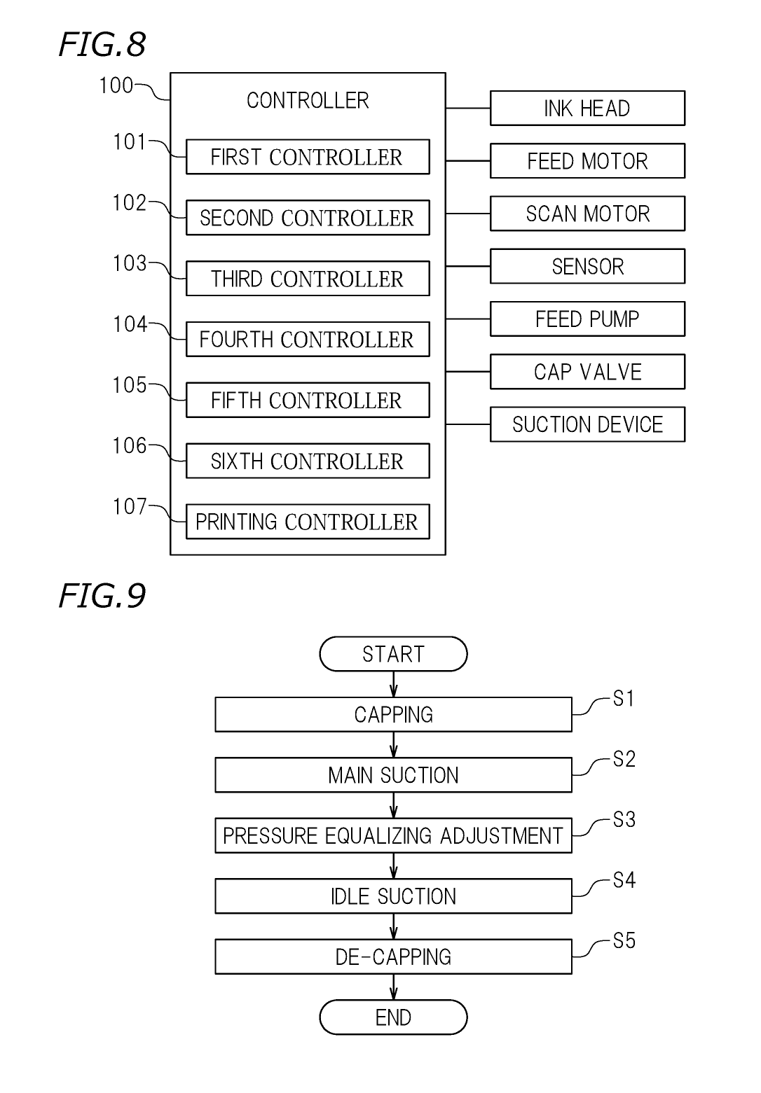

As illustrated in FIG. 1, the printer 1 effects printing on the recording medium 8. The printer 1 includes a body 2, legs 4, a guide rail 10, ink tanks 21, a cap unit 40, a guide device 50, and a controller 100 (see FIG. 8). The body 2 is supported by the legs 4. The legs 4 are provided on the lower surface of the body 2. The front portion of the body 2 is provided with a platen 6. The recording medium 8 is placed on the platen 6.

In the present preferred embodiment, the recording medium 8 is rolled recording paper or “rolled paper”. The recording medium 8, however, is not limited to rolled recording paper. The recording medium 8 may be any medium other than paper (e.g., plain paper and inkjet printing paper). Examples of the recording medium 8 include: a resin sheet or film made of polyvinyl chloride or polyester, for example; a plate material; and a fabric, such as a woven fabric or a nonwoven fabric. The recording medium 8 may be any other suitable medium. In the present preferred embodiment, a material for the recording medium 8 is not limited to any particular material.

As illustrated in FIG. 1, the printer 1 includes the platen 6 on which the recording medium 8 is to be placed. The platen 6 is provided with cylindrical grit rollers 16 that define and function as components of a recording medium conveyor. The grit rollers 16 are embedded in the platen 6, with the upper surfaces of the grit rollers 16 exposed. The grit rollers 16 are driven by a feed motor (not illustrated).

As illustrated in FIG. 1, the guide rail 10 is disposed above the platen 6. The guide rail 10 is disposed in parallel or substantially in parallel with the platen 6. The guide rail 10 extends in the main scanning direction Y. The printer 1 further includes a plurality of pinch rollers 18 disposed below the guide rail 10. The pinch rollers 18 are located at equal or substantially equal intervals. The pinch rollers 18 each face an associated one of the grit rollers 16. The position of each pinch roller 18 in the up-down direction Z is adjustable in accordance with the thickness of the recording medium 8. The recording medium 8 is sandwiched between each pinch roller 18 and the associated grit roller 16. Rotating the grit rollers 16 by the feed motor enables the grit rollers 16 and the pinch rollers 18 to convey the recording medium 8 in the sub-scanning direction X, with the recording medium 8 sandwiched between each grit roller 16 and the associated pinch roller 18. The grit rollers 16, the pinch rollers 18, and the feed motor are provided as an example of the recording medium conveyor to move the recording medium 8 and the ink head unit 30 (which will be described below) relative to each other in the sub-scanning direction X.

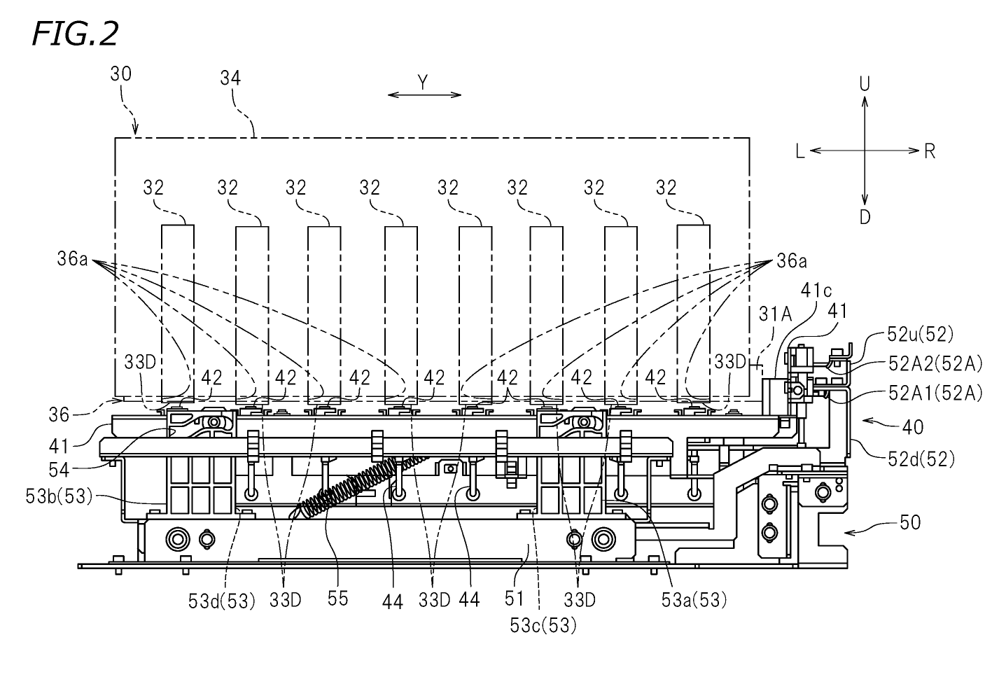

The printer 1 includes the ink head unit 30. As illustrated in FIG. 2, the ink head unit 30 includes ink heads 32, a case 34, and a head plate 36. The ink head unit 30 is mounted on a carriage 31 (see FIG. 1). The number of ink heads 32 included in the ink head unit 30 may be one or may be two or more. To meet recent demands for printers to effect high speed, high quality printing, the number of ink heads included in each printer is increasing. In the present preferred embodiment, the number of ink heads 32 is eight in total, for example. Specifically, the ink head unit 30 includes an ink head 32A, an ink head 32B, an ink head 32C, an ink head 32D, an ink head 32E, an ink head 32F, an ink head 32G, and an ink head 32H. As used herein, the term “ink head 32” refers to any one of the ink heads 32A to 32H. As used herein, the term “ink heads 32” refers to any two or more of the ink heads 32A to 32H or all of the ink heads 32A to 32H. The head plate 36 retains the ink heads 32A to 32H. The head plate 36 is secured to the carriage 31. A region above the head plate 36 and the ink heads 32A to 32H are covered with the case 34. The case 34 is disposed on the carriage 31. An end of the carriage facing in the rightward direction R includes an engagement portion 31A that comes into engagement with the cap unit 40 (which will be described below). The back surface of a rear potion of the carriage 31 is provided with a recess 31B (see FIG. 1) recessed forward.

As illustrated in FIG. 1, the upper portion of the guide rail 10 supports a timing belt 12 extending in the main scanning direction Y. The timing belt 12 is an annular endless belt. The timing belt 12 is wound around a timing pulley and a driven pulley (which are not illustrated). The timing pulley is disposed on one of the right and left ends of the guide rail 10, and the driven pulley is disposed on the other one of the right and left ends of the guide rail 10. The timing pulley is connected to a scan motor (not illustrated). Rotating the scan motor causes the timing belt 12 to run around the timing pulley and the driven pulley. The guide rail 10 includes an engagement portion 14 protruding forward. The engagement portion 14 of the guide rail 10 and the recess 31B of the carriage 31 are in slidable engagement with each other. Running of the timing belt 12 moves the carriage 31 in the main scanning direction Y along the guide rail 10. The movement of the carriage 31 enables the ink head unit 30 to move in the main scanning direction Y along the guide rail 10. The ink head unit 30 is disposed above the platen 6, with the carriage 31 located between the ink head unit 30 and the platen 6. The carriage 31, the guide rail 10, the timing belt 12, the timing pulley, the driven pulley, and the scan motor are provided as an example of an ink head conveyor to move the ink head unit 30 relative to the recording medium 8 in the main scanning direction Y.

The ink heads 32A to 32H each have a cuboid or substantially cuboid shape, for example. The length of each of the ink heads 32A to 32H in the front-rear direction X is longer than the length of each of the ink heads 32A to 32H in the right-left direction Y. The ink heads 32A to 32H are identical or substantially identical in shape and size. As illustrated in FIG. 2, the head plate 36 is provided with through holes 36a through which the ink heads 32A to 32H are secured in position. The through holes 36a are provided in accordance with the arrangement of the ink heads 32A to 32H. The ink heads 32A to 32H are disposed in the head plate 36. In order to effect high-resolution printing in a short time, the present preferred embodiment involves disposing the ink heads 32A to 32H such that the ink heads 32 having the same functions are provided in pairs and the ink heads 32 of each pair are adjacent to each other and out of alignment with each other in the front-rear direction X. This enables the printer 1 to effect printing with a print span doubled in the sub-scanning direction X. The ink head 32A pairs up with the ink head 32B. The ink head 32C pairs up with the ink head 32D. The ink head 32E pairs up with the ink head 32F. The ink head 32G pairs up with the ink head 32H. The ink heads 32A, 32C, 32E, and 32G are disposed in the head plate 36 such that the ink heads 32A, 32C, 32E, and 32G are aligned in the main scanning direction Y. The ink heads 32B, 32D, 32F, and 32H are disposed in the head plate 36 such that the ink heads 32B, 32D, 32F, and 32H are aligned in the main scanning direction Y. The ink heads 32A, 32C, 32E, and 32G are respectively out of alignment with the ink heads 32B, 32D, 32F, and 32H in the front-rear direction X such that the ink heads 32A, 32C, 32E, and 32G are respectively disposed on the front side F relative to the ink heads 32B, 32D, 32F, and 32H, and the ink heads 32B, 32D, 32F, and 32H are respectively disposed on the rear side Rr relative to the ink heads 32A, 32C, 32E, and 32G. The ink heads 32A to 32H are basically identical or substantially identical in configuration. The ink heads 32A and 32B provided in a pair are basically identical or substantially identical in configuration. The ink heads 32C and 32D provided in a pair are basically identical or substantially identical in configuration. The ink heads 32E and 32F provided in a pair are basically identical or substantially identical in configuration. The ink heads 32G and 32H provided in a pair are basically identical or substantially identical in configuration. Accordingly, when distinctions between the pairs are unnecessary, attention will be focused on the pair of ink heads 32A and 32B. When a distinction between the ink head 32A and the ink head 32B is unnecessary, attention will be focused on the ink head(s) 32.

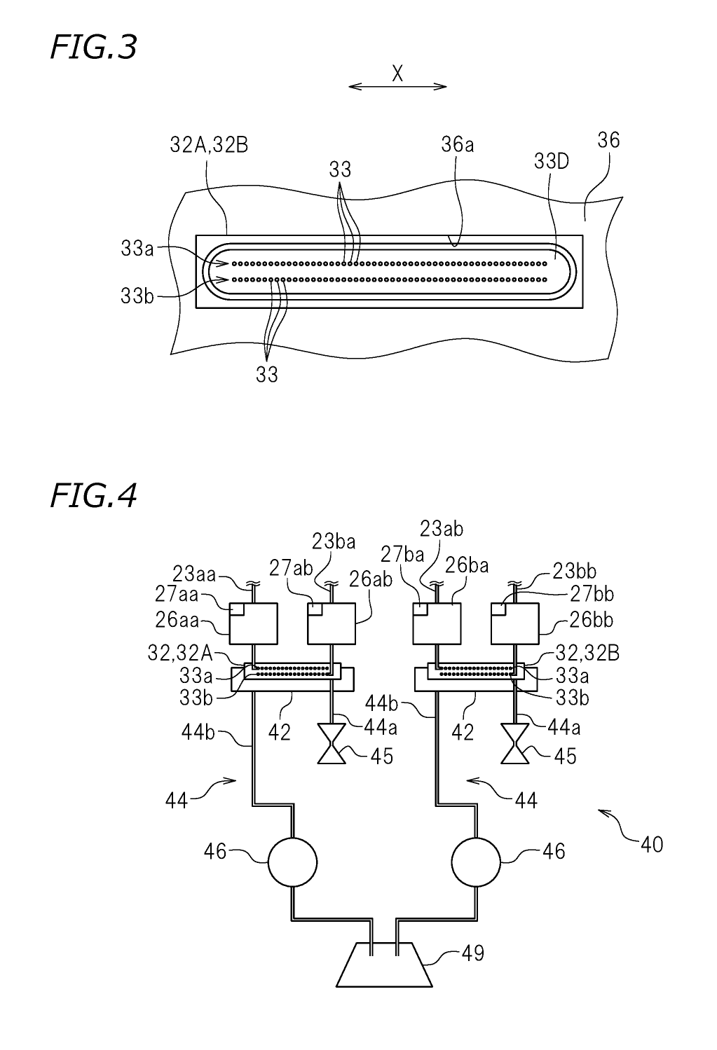

The following description briefly discusses the structure of each ink head 32 and ink feeders. The following description focuses on the pair of ink heads 32A and 32B. FIG. 3 is a bottom view of the ink head 32A or 32B secured to the head plate 36. The lower surface of each of the ink heads 32A and 32B is a nozzle surface 33D. The nozzle surface 33D of each of the ink heads 32A and 32B is provided with a large number of nozzles 33. The nozzles 33 discharge ink onto the recording medium 8. The nozzles 33 of each nozzle surface 33D are arranged in two rows parallel or substantially parallel to each other in the sub-scanning direction X. One of the two rows is a first nozzle row 33a. The other one of the two rows is a second nozzle row 33b. The first and second nozzle rows 33a and 33b each include 360 nozzles 33 per inch. The nozzles 33 of the first nozzle row 33a are aligned in the sub-scanning direction X. The nozzles 33 of the second nozzle row 33b are aligned in the sub-scanning direction X. The first and second nozzle rows 33a and 33b are exposed to the outside of the head plate 36 through the through holes 36a of the head plate 36. As illustrated in FIG. 2, the nozzle surface 33D of each ink head 32 is located below the lower surface of the head plate 36.

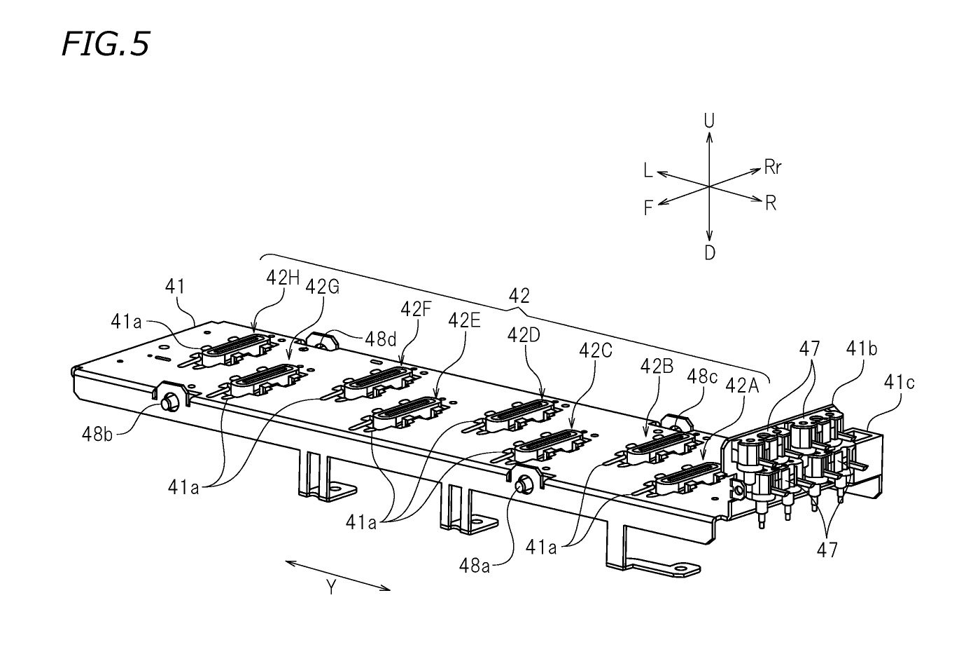

FIG. 4 is a schematic diagram illustrating ink discharge paths of the printer 1 and portions of ink feed paths of the printer 1. The portion of FIG. 4 above the ink heads 32A and 32B illustrates the ink feed paths. The portion of FIG. 4 below caps 42 illustrates the ink discharge paths. The printer 1 includes ink feeders (not illustrated). Although not illustrated in detail, each ink feeder is a system to feed ink from the associated ink tanks 21 (see FIG. 1) to the nozzles 33 arranged in the associated ink heads 32. In the following description, portions of the ink feed paths adjacent to the ink tanks 21 may be referred to as an “upstream side”, and portions of the ink feed paths adjacent to the ink heads 32 may be referred to as a “downstream side”. In the following description, portions of the ink discharge paths adjacent to the caps 42 may be referred to as an “upstream side”, and portions of the ink discharge paths adjacent to a waste liquid bottle 49 may be referred to as a “downstream side”. In the present preferred embodiment, the number of ink tanks 21 included in the printer 1 is eight, for example. Alternatively, the printer 1 may include any other number of ink tanks 21. In the present preferred embodiment, the number of ink heads 32 included in the printer 1 is eight, for example. Alternatively, the printer 1 may include any other number of ink heads 32. The ink feed paths leading to the ink heads 32 from the ink tanks 21 are identical or substantially identical in configuration. The ink feed paths to send ink to the ink heads 32A and 32B from the associated two ink tanks 21 will be briefly described below. One of the two ink tanks 21 associated with the ink heads 32A and 32B may hereinafter be referred to as a “first ink tank 21”. The other one of the two ink tanks 21 associated with the ink heads 32A and 32B may hereinafter be referred to as a “second ink tank 21”.

The ink feeder illustrated in FIG. 4 includes the first and second ink tanks 21 (see FIG. 1), the ink heads 32A and 32B, pressure control valves (not illustrated), feed pumps (not illustrated), ink passages 23aa, 23ab, 23ba, and 23bb, dampers 26aa, 26ab, 26ba, and 26bb, and sensors 27aa, 27ab, 27ba, and 27bb.

The first and second ink tanks 21 each store ink. In the present preferred embodiment, the number of ink tanks 21 is equal to the number of ink heads 32. The first and second ink tanks 21 according to the present preferred embodiment are each connected to the ink heads 32A and 32B. The ink heads 32A and 32B are each provided with a pair of nozzle rows, i.e., the first and second nozzle rows 33a and 33b. The ink stored in the first ink tank 21 is fed to the first nozzle row 33a of the ink head 32A and the first nozzle row 33a of the ink head 32B. The ink stored in the second ink tank 21 is fed to the second nozzle row 33b of the ink head 32A and the second nozzle row 33b of the ink head 32B. The ink tanks 21 normally store ink of different colors. In the present preferred embodiment, the first ink tank 21 stores yellow ink, and the second ink tank 21 stores black ink. Alternatively, some of the ink tanks 21 may store ink of the same color. The ink stored in each ink tank 21 is not limited to any particular color. In one example, the ink stored in each ink tank 21 may be any one of: process color ink, such as cyan ink, magenta ink, yellow ink, black ink, light cyan ink, light magenta ink, and light black ink; and spot color ink, such as white ink, metallic ink, and clear ink.

The ink passages 23aa and 23ba are passages through which the ink stored in the first and second ink tanks 21 is fed to the ink head 32A. The ink passages 23ab and 23bb are passages through which the ink stored in the first and second ink tanks 21 is fed to the ink head 32B. More specifically, the ink passages 23aa and 23ba are passages through which the ink stored in the first and second ink tanks 21 is fed to the nozzles 33 of the ink head 32A. The ink passages 23ab and 23bb are passages through which the ink stored in the first and second ink tanks 21 is fed to the nozzles 33 of the ink head 32B. The ink passages 23aa, 23ab, 23ba, and 23bb are not limited to any particular type or material. In one example, each of the ink passages 23aa, 23ab, 23ba, and 23bb is a flexible silicon tube. The ink passages 23aa and 23ab are connected to the first ink tank 21. The ink passage 23aa is connected to the first nozzle row 33a of the ink head 32A. The ink passage 23ab is connected to the first nozzle row 33a of the ink head 32B. The ink passages 23ba and 23bb are connected to the second ink tank 21. The ink passage 23ba is connected to the second nozzle row 33b of the ink head 32A. The ink passage 23bb is connected to the second nozzle row 33b of the ink head 32B. Thus, two different types of ink are fed to each of the ink heads 32A and 32B from the first and second ink tanks 21. The ink passage 23aa and the ink passage 23ab may be combined into a single passage on the upstream side. The ink passage 23ba and the ink passage 23bb may be combined into a single passage on the upstream side. In other words, the ink passages 23aa and 23ab may be passages branching off from an ink passage connected to the first ink tank 21, and the ink passages 23ba and 23bb may be passages branching off from an ink passage connected to the second ink tank 21.

Each feed pump is provided at a location somewhere along an associated one of the ink passages 23aa, 23ab, 23ba, and 23bb. Each feed pump sends a fluid (e.g., ink) in an associated one of the ink passages 23aa, 23ab, 23ba, and 23bb from the upstream side to the downstream side. During operation, the feed pumps send ink from the first and second ink tanks 21 to the ink heads 32A and 32B. Each feed pump is not limited to any particular type. In one example, each feed pump is a tube pump. The tube pump internally includes an inner tube and a roller. The tube pump rotates the roller in a planetary manner while the roller crushes the inner tube, so that ink is sent in the direction of travel of the roller. The tube pump may send ink from the downstream side to the upstream side by rotating the roller in a planetary manner in a reverse direction.

Each pressure control valve is provided in a portion of an associated one of the ink passages 23aa, 23ab, 23ba, and 23bb located between the associated ink tank 21 and the associated feed pump. Each pressure control valve maintains the inside of the nozzles 33 of an associated one of the ink heads 32A and 32B at a negative pressure when no ink is being discharged from the nozzles 33. As used herein, the term “negative pressure” refers to a pressure lower than an external pressure (which is typically atmospheric pressure). Maintaining the inside of the ink heads 32A and 32B at a negative pressure prevents ink in the ink heads 32A and 32B from trickling down to the outside through the nozzles 33. Each pressure control valve maintains ink in the nozzles 33 of the ink heads 32A and 32B at about −1 kPa. Each pressure control valve includes: a passage through which ink flows; and a valve operator to open and close the passage. The valve operator is structured to open and close in accordance with the fluid pressure in a region downstream of the valve operator. The valve operator receives the pressure of ink upstream of the valve operator, the pressure of ink downstream of the valve operator, a mechanical force that will close the valve operator, and a mechanical force that will open the valve operator. When the printer 1 is not in use, these pressures and forces keep their balance. In such a balanced state, the valve operator seals the passage. The pressure of ink in this state is the pressure of ink at rest, which is maintained at about −1 kPa, for example. The mechanical force that will close or open the valve operator is, for example, a restoring force of a spring. Activating a suction pump 46 sucks out ink from a region downstream of the valve operator. This reduces the pressure of ink on the downstream side so as to disturb the balance, causing the valve operator to open. Once the valve operator opens, the passage is opened so as to feed ink in the downstream direction. With such a mechanism, each pressure control valve maintains ink at a negative pressure when the printer 1 is not in use, and sends ink to an associated one of the ink heads 32A and 32B when the printer 1 is in use.

As illustrated in FIG. 4, the damper 26aa is provided at a location somewhere along the ink passage 23aa, the damper 26ab is provided at a location somewhere along the ink passage 23ba, the damper 26ba is provided at a location somewhere along the ink passage 23ab, and the damper 26bb is provided at a location somewhere along the ink passage 23bb. The dampers 26aa and 26ab are provided immediately upstream of the ink head 32A. The dampers 26ba and 26bb are provided immediately upstream of the ink head 32B. The dampers 26aa and 26ab store ink to be sent to the ink head 32A, so as to reduce variations in ink pressure and stabilize discharge operation of the ink head 32A. The dampers 26ba and 26bb store ink to be sent to the ink head 32B, so as to reduce variations in ink pressure and stabilize discharge operation of the ink head 32B. The damper 26aa according to the present preferred embodiment includes: a storage chamber to store ink; and the sensor 27aa to detect the pressure of ink stored in the storage chamber. The damper 26ab according to the present preferred embodiment includes: a storage chamber to store ink; and the sensor 27ab to detect the pressure of ink stored in the storage chamber. The damper 26ba according to the present preferred embodiment includes: a storage chamber to store ink; and the sensor 27ba to detect the pressure of ink stored in the storage chamber. The damper 26bb according to the present preferred embodiment includes: a storage chamber to store ink; and the sensor 27bb to detect the pressure of ink stored in the storage chamber. The pressure of ink stored in each of the storage chambers is equal or substantially equal to the pressure inside the nozzles 33. Each of the sensors 27aa, 27ab, 27ba, and 27bb is an example of a detector to detect the pressure inside the nozzles 33. During printing, each of the dampers 26aa, 26ab, 26ba, and 26bb keeps the pressure of ink stored in the storage chamber within a predetermined range so as to reduce variations in ink pressure. In one example, each of the sensors 27aa, 27ab, 27ba, and 27bb is a photosensor for position detection. One of wall surfaces of the storage chamber of each of the dampers 26aa, 26ab, 26ba, and 26bb is a film that expands and contracts so as to deform in a concavo-convex manner in response to the pressure of ink stored in the storage chamber. Each of the sensors 27aa, 27ab, 27ba, and 27bb detects the pressure of ink inside the storage chamber in accordance with the concavo-convex deformation of the film. When the film expands beyond a first reference position, the sensor 27aa, 27ab, 27ba, or 27bb transmits an upper limit signal to the controller 100. When the film contracts to a second reference position, the sensor 27aa, 27ab, 27ba, or 27bb transmits a lower limit signal to the controller 100. Upon receiving the upper limit signal or the lower limit signal, the controller 100 rotates the feed pump(s) in a forward direction or a reverse direction so as to start or stop feeding ink. The pressure detector of each of the dampers 26aa, 26ab, 26ba, and 26bb may naturally be any detector other than the sensor described above.

As illustrated in FIG. 1, the printer 1 includes the cap unit 40. The cap unit 40 protects the ink heads 32A to 32H from drying of ink and adhesion of foreign matter when the printer 1 effects no printing. The cap unit 40 also performs suction cleaning for the ink heads 32A to 32H. The cap unit 40 is disposed in a side cover 15 located rightward of the platen 6. The cap unit 40 is disposed below the ink head unit 30. As illustrated in FIGS. 2 and 4, the cap unit 40 includes a movable table 41, the caps 42, passages 44, cap valves 45, the suction pumps 46, the waste liquid bottle 49, and the guide device 50.

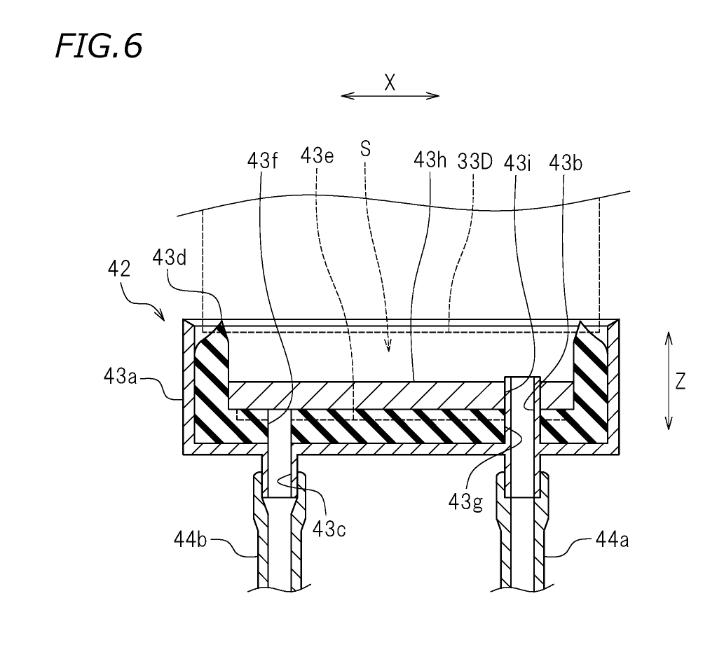

As illustrated in FIG. 5, the number of caps 42 included in the cap unit 40 is eight in total, for example. Specifically, the cap unit 40 includes a cap 42A, a cap 42B, a cap 42C, a cap 42D, a cap 42E, a cap 42F, a cap 42G, and a cap 42H. The caps 42A to 42H are basically identical or substantially identical in configuration. Accordingly, the term “cap 42” or the term “caps 42” will be used when distinctions between the caps 42A to 42H are unnecessary. A set of the passage 44, the cap valve 45, and the suction pump 46 is provided between each of the caps 42A to 42H and the waste liquid bottle 49. The arrangements of components between the waste liquid bottle 49 and the caps 42A to 42H are the same or substantially the same. Thus, for the sake of simplification of description, the components provided between the waste liquid bottle 49 and the caps 42A to 42H and having the same functions are identified by the same reference signs.

The caps 42A to 42H are respectively detachably attachable to the ink heads 32A to 32H so as to respectively cover the nozzle surfaces 33D of the ink heads 32A to 32H. As used herein, the phrase “to cover the nozzle surface 33D” refers to not only covering an entirety of the nozzle surface 33D but also covering at least the first nozzle row 33a and the second nozzle row 33b of the nozzle surface 33D. The caps 42A to 42H are disposed in the movable table 41. The caps 42A to 42H are each fitted into an associated one of openings 41a provided in the movable table 41. The movable table 41 is made of a single steel plate. The openings 41a are provided by punching. The openings 41a of the movable table 41 are provided at predetermined locations such that the arrangement of the caps 42A to 42H corresponds to the arrangement of the ink heads 32A to 32H disposed in the head plate 36. Specifically, four of the eight caps 42, i.e., the caps 42A, 42C, 42E, and 42G, are arranged at equal or substantially intervals in the main scanning direction Y and disposed in a relatively forward portion of the movable table 41. The other four of the eight caps 42, i.e., the caps 42B, 42D, 42F, and 42H, are arranged at equal or substantially intervals in the main scanning direction Y and disposed in a relatively rearward portion of the movable table 41. The relatively forwardly disposed cap 42A pairs up with the relatively rearwardly disposed cap 42B adjacent thereto. The relatively forwardly disposed cap 42C pairs up with the relatively rearwardly disposed cap 42D adjacent thereto. The relatively forwardly disposed cap 42E pairs up with the relatively rearwardly disposed cap 42F adjacent thereto. The relatively forwardly disposed cap 42G pairs up with the relatively rearwardly disposed cap 42H adjacent thereto.

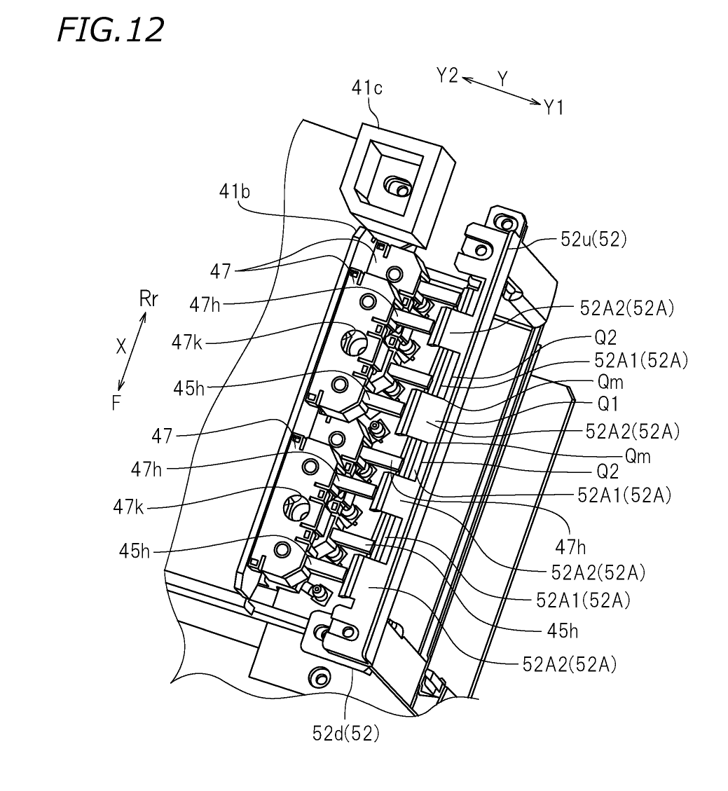

As illustrated in FIG. 12, an end of the movable table 41 facing in the rightward direction R includes a table wall 41b. The table wall 41b is provided by sheet metal processing. In one example, the table wall 41b is provided by bending, in the upward direction U, the right end of the steel plate that constitutes the movable table 41 (see FIG. 5). An end of the movable table 41 facing in the rightward direction R and located on the rear side Rr includes a stopper 41c. The stopper 41c comes into engagement with the engagement portion 31A (see FIG. 2) of the carriage 31 that moves in the main scanning direction Y. The stopper 41c is an example of an engaging member. The lower end of the stopper 41c is joined to the upper surface of the steel plate that constitutes the movable table 41. A lateral surface of the movable table 41 on the front side F is provided with a guide pin 48a located on the right side R and a guide pin 48b located on the left side L. A lateral surface of the movable table 41 on the rear side Rr is provided with a guide pin 48c located on the right side R and a guide pin 48d located on the left side L. With the guide pins 48a, 48b, 48c, and 48d, the movable table 41 is supported by the guide device 50.

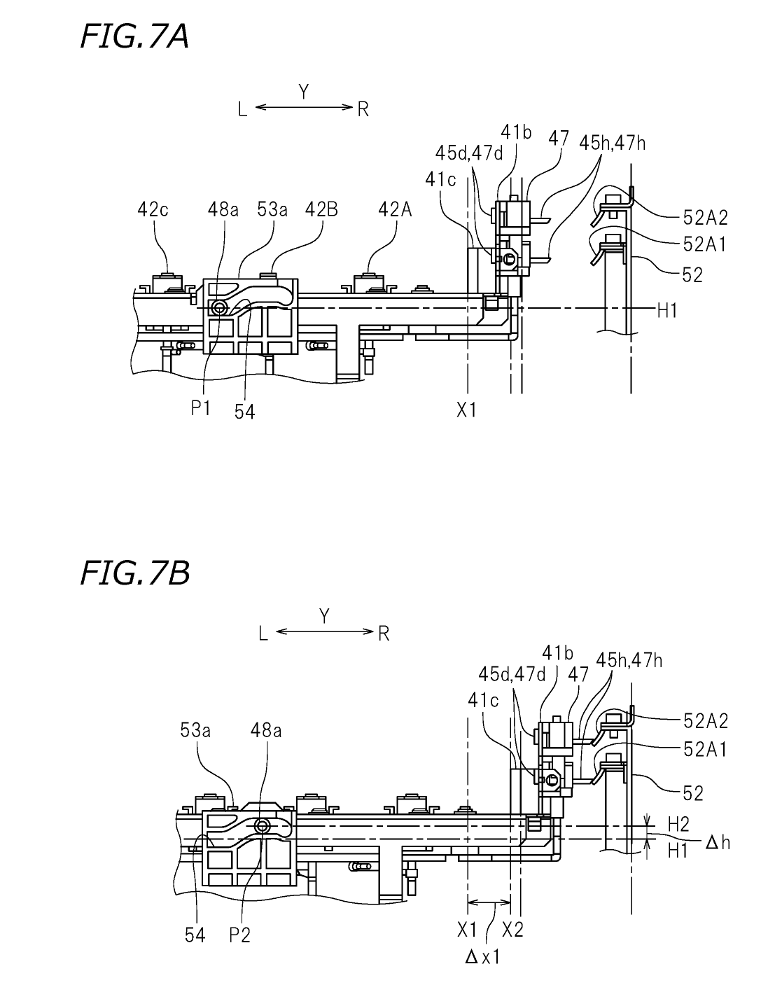

As illustrated in FIG. 6, each cap 42 includes a body case 43a, a lip 43d, and an absorber 43h. Each cap 42 is detachably attachable to the associated ink head 32 so as to cover the nozzle surface 33D (see FIG. 3) of the associated ink head 32. Attaching each cap 42 to the associated ink head 32 defines an enclosed space S between each cap 42 and the nozzle surface 33D of the associated ink head 32.

The body case 43a includes a bottom and a side wall. The body case 43a has a box shape having an upwardly facing opening. The bottom and the side wall of the body case 43a define a recess. The absorber 43h is held in the recess. The side wall of the body case 43a has a shape conforming to the nozzle surface 33D (see FIG. 3) of the associated ink head 32. In one example, the side wall of the body case 43a has an oval shape in the plan view. The side wall of the body case 43a is structured such that the nozzle surface 33D of the associated ink head 32 is fitted into the body case 43a. The bottom of the body case 43a is provided with a protrusive hole 43b protruding upward, and a through hole 43c. The lower ends of the protrusive hole 43b and the through hole 43c are each provided with a protrusion protruded in the downward direction D from the bottom of the body case 43a such that the protrusive hole 43b and the through hole 43c are connectable to the associated passage 44. The lower ends of the protrusive hole 43b and the through hole 43c are protruded in the downward direction D from the movable table 41. The protrusive hole 43b is connected with an associated one of opening/closing passages 44a (which will be described below). The upper end of the protrusive hole 43b is located at the same height as the upper surface of the absorber 43h or above the upper surface of the absorber 43h. The upper end of the protrusive hole 43b is located below the upper end of the lip 43d. With each cap 42 attached to the associated ink head 32, the upper end of the protrusive hole 43b is located in the enclosed space S defined between the upper surface of the absorber 43h and the nozzle surface 33D. The lower end of the through hole 43c is connected with an associated one of suction passages 44b (which will be described below). The protrusive hole 43b defines and functions as a portion of a first passage. The through hole 43c defines and functions as a portion of a second passage.

The lip 43d is held in the opening of the body case 43a. The lip 43d includes a bottom and a side wall. The lip 43d is provided with an opening facing upward. The upper end of the side wall of the lip 43d decreases in thickness (or width) as it extends upward. The lip 43d is made of an elastically deformable material. In one example, the lip 43d is made of rubber. The lip 43d is provided in the body case 43a such that the lip 43d elastically comes into contact with the nozzle surface 33D of the associated ink head 32. Bringing the lip 43d into contact with the nozzle surface 33D of the associated ink head 32 defines the enclosed space S. The bottom of the lip 43d is provided with a through hole 43g and a through hole 43f. The protrusive hole 43b passes through the through hole 43g. The through hole 43f is in communication with the through hole 43c and the suction passage 44b. The upper surface of the bottom of the lip 43d is provided with a groove 43e recessed in the downward direction D. The groove 43e is in communication with the through hole 43f. The groove 43e extends across the entire or substantially the entire surface of the bottom of the lip 43d.

The absorber 43h is held in the opening (or recess) of the lip 43d. The absorber 43h is made of an air-permeable porous material capable of absorbing ink. Examples of the porous material include a sponge, a woven fabric, and a nonwoven fabric. The absorber 43h includes a through hole 43i. The protrusive hole 43b passes through the through hole 43i. The upper surface of the absorber 43h is located below the upper end of the lip 43d. The upper surface of the absorber 43h is located at the same height as the upper end of the protrusive hole 43b or below the upper end of the protrusive hole 43b.

As illustrated in FIG. 4, each passage 44 includes the opening/closing passage 44a and the suction passage 44b. As previously mentioned, the upstream end of each opening/closing passage 44a is connected to the protrusive hole 43b of the associated cap 42, and the upstream end of each suction passage 44b is connected to the through hole 43c of the associated cap 42. The opening/closing passage 44a is an example of the first passage that connects an associated one of the caps 42 to an associated one of the cap valves 45 (which will be described below). The downstream end of each suction passage 44b is inserted into the waste liquid bottle 49. Each suction passage 44b is an example of the second passage that connects an associated one of the caps 42 to an associated one of the suction pumps 46 (which will be described below). Each passage 44 includes a flexible tube (e.g., a silicon tube).

Each cap valve 45 is provided at a location somewhere along the associated opening/closing passage 44a or on an end of the associated opening/closing passage 44a. Each cap valve 45 is connected to an associated one of the caps 42 through the associated opening/closing passage 44a. Each cap valve 45 switches the associated opening/closing passage 44a between an open state and a closed state. Specifically, each cap valve 45 performs switching between the open state where the inside of the associated opening/closing passage 44a is in communication with the outside of the associated opening/closing passage 44a and the closed state where the inside of the associated opening/closing passage 44a is out of communication with the outside of the associated opening/closing passage 44a. Each cap valve 45 may have any configuration and operator as long as it dynamically performs switching between the open state and the closed state. Each cap valve 45 may be a “control valve” that switches between the open state and the closed state using at least one of water (i.e., vapor), air, electricity, magnetism, and hydraulic pressure to be supplied separately. Each cap valve 45 may be a valve that switches between the open state and the closed state by a mechanical operation. Each cap valve 45 according to the present preferred embodiment is, for example, a piston valve openable and closable by a small actuating force provided by a mechanical operation. The piston valve includes a piston valve element. As used herein, the term “mechanical operation” refers to an operation by which an actuating force for switching is transmitted from a valve switching power source to the piston valve element through a mechanical contact. Such an actuating force typically changes the three-dimensional position of the piston valve element. Thus, the “mechanical operation” differs from, for example, an operation by which switching is performed using an electric or magnetic force that acts on the piston valve element from the switching power source without going through any mechanical contact. Such an operation is performed by an electromagnetic valve, for example. As illustrated in FIG. 5, the cap unit 40 includes a plurality of composite cap valves 47. Each of the composite cap valves 47 includes two of the cap valves 45 integral with each other. The number of composite cap valves 47 included in the cap unit 40 is four, for example.

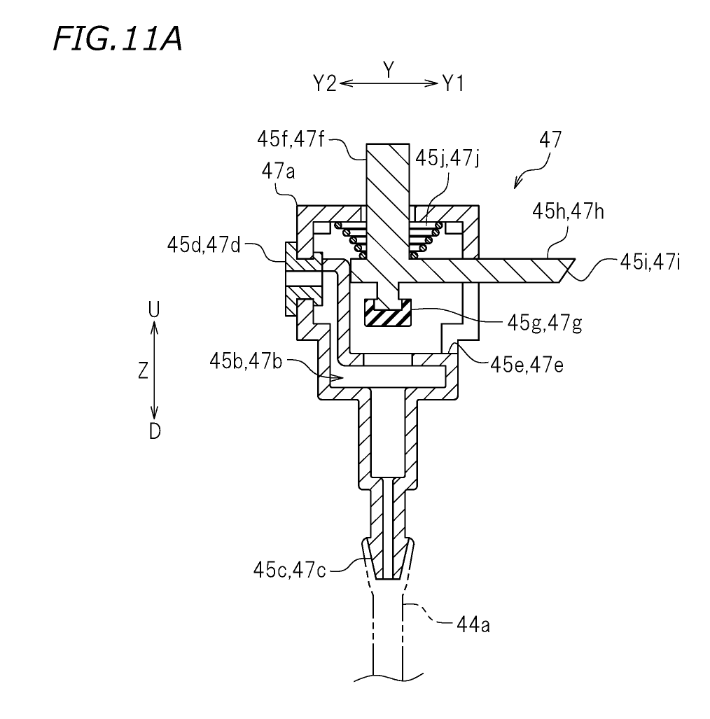

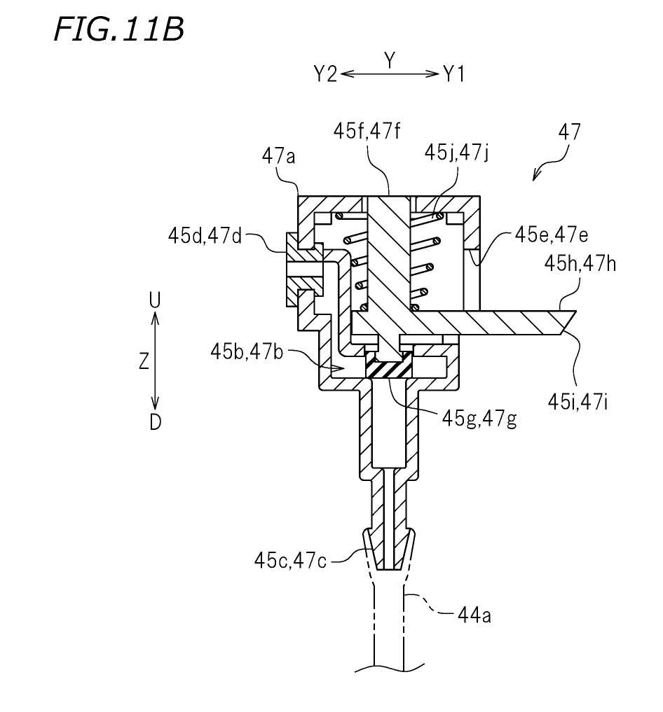

FIG. 10 is a front view of the composite cap valve 47. FIGS. 11A and 11B are cross-sectional views of the composite cap valve 47. Each composite cap valve 47 includes a composite valve case 47a. As indicated by the reference characters A and B in FIG. 10, components of two cap valves 45 are held in the composite valve case 47a of each composite cap valve 47. Each composite cap valve 47 includes the composite valve case 47a, a piston valve element 45f, a piston valve element 47f, a spring 45j, and a spring 47j. The composite valve case 47a includes an inlet 45c, an inlet 47c, an outlet 45d, an outlet 47d, an opening 45e, and an opening 47e. The composite valve case 47a internally includes: an inner passage 45b through which the inlet 45c and the outlet 45d are in communication with each other; and an inner passage 47b through which the inlet 47c and the outlet 47d are in communication with each other. The inlets 45c and 47c are each protruded in the downward direction D from the lower surface of the composite valve case 47a. The outlets 45d and 47d are each protruded rearward from the back surface of the composite valve case 47a. The openings 45e and 47e are disposed in the front surface of the composite valve case 47a. The openings 45e and 47e are each elongated in the up-down direction Z.

A large portion of each of the piston valve elements 45f and 47f is held in the composite valve case 47a. The piston valve elements 45f and 47f are movable in the up-down direction Z inside the composite valve case 47a. When the piston valve elements 45f and 47f are located at closing positions (i.e., lowermost positions), the piston valve elements 45f and 47f respectively close the inner passages 45b and 47b (see FIG. 11B). With the piston valve elements 45f and 47f located at the closing positions, the lower ends of the piston valve elements 45f and 47f respectively intersect and block at least portions of the inner passages 45b and 47b. The lower end of the piston valve element 45f is provided with a gasket 45g to tightly seal the inner passage 45b, with the piston valve element 45f located at the closing position. The lower end of the piston valve element 47f is provided with a gasket 47g to tightly seal the inner passage 47b, with the piston valve element 47f located at the closing position. When the piston valve elements 45f and 47f are located on the upper side U relative to the closing positions, the piston valve elements 45f and 47f respectively open the inner passages 45b and 47b (see FIG. 11A). With the piston valve elements 45f and 47f located on the upper side U relative to the closing positions, the upper ends of the piston valve elements 45f and 47f protrude out of the composite valve case 47a. The springs 45j and 47j are held in the composite valve case 47a. Each of the springs 45j and 47j is a compression coil spring including an end secured to an inner wall of the composite valve case 47a. The piston valve elements 45f and 47f are respectively disposed inside the coils of the springs 45j and 47j. The piston valve element 45f is urged by gravity and the spring 45j such that the piston valve element 45f is located at the closing position under normal conditions. The piston valve element 47f is urged by gravity and the spring 47j such that the piston valve element 47f is located at the closing position under normal conditions. The spring 45j urges the piston valve element 45f to the closing position and guides movement of the piston valve element 45f in the up-down direction Z. The spring 47j urges the piston valve element 47f to the closing position and guides movement of the piston valve element 47f in the up-down direction Z.

The piston valve element 45f includes a rod 45h protruding in the main scanning direction Y. The piston valve element 47f includes a rod 47h protruding in the main scanning direction Y. Each of the rods 45h and 47h is an example of a switching member. A first end of the rod 45h is secured to the piston valve element 45f. A first end of the rod 47h is secured to the piston valve element 47f. The first end of the rod 45h is secured to a portion of the piston valve element 45f adjacent to the lower end of the piston valve element 45f. The first end of the rod 47h is secured to a portion of the piston valve element 47f adjacent to the lower end of the piston valve element 47f. A second end of the rod 45h extends out of the composite valve case 47a through the opening 45e. A second end of the rod 47h extends out of the composite valve case 47a through the opening 47e. The second end of the rod 45h includes an inclined surface 45i extending obliquely upward to the right such that the second end of the rod 45h tapers to its upper tip. The second end of the rod 47h includes an inclined surface 47i extending obliquely upward to the right such that the second end of the rod 47h tapers to its upper tip. At normal times, the piston valve element 45f is urged to the closing position by the spring 45j, so that the rod 45h of the piston valve element 45f passes through a lower region of the opening 45e. At normal times, the piston valve element 47f is urged to the closing position by the spring 47j, so that the rod 47h of the piston valve element 47f passes through a lower region of the opening 47e. Lifting the rod 45h in the upward direction U moves the rod 45h in the upward direction U through the opening 45e. Lifting the rod 47h in the upward direction U moves the rod 47h in the upward direction U through the opening 47e. In accordance with the movement of the rod 45h in the upward direction U, the piston valve element 45f moves in the upward direction U against the elastic force of the spring 45j. In accordance with the movement of the rod 47h in the upward direction U, the piston valve element 47f moves in the upward direction U against the elastic force of the spring 47j. The movement of the piston valve elements 45f and 47f in the upward direction U opens the composite cap valve 47. The rods 45h and 47h are liftable independently or in conjunction with each other. Thus, the two cap valves 45 of each composite cap valve 47 are openable and closable independently or in conjunction with each other.

The composite valve case 47a may be divided into: a first cap valve area A including the inner passage 45b, the piston valve element 45f, the rod 45h, and the spring 45j; and a second cap valve area B including the inner passage 47b, the piston valve element 47f, the rod 47h, and the spring 47j. The first cap valve area A defines and functions as one of the two cap valves 45 of the composite cap valve 47. The second cap valve area B defines and functions as the other one of the two cap valves 45 of the composite cap valve 47. The composite valve case 47a includes a through hole 47k between the first cap valve area A and the second cap valve area B. The through hole 47k passes through the composite valve case 47a in the up-down direction Z.

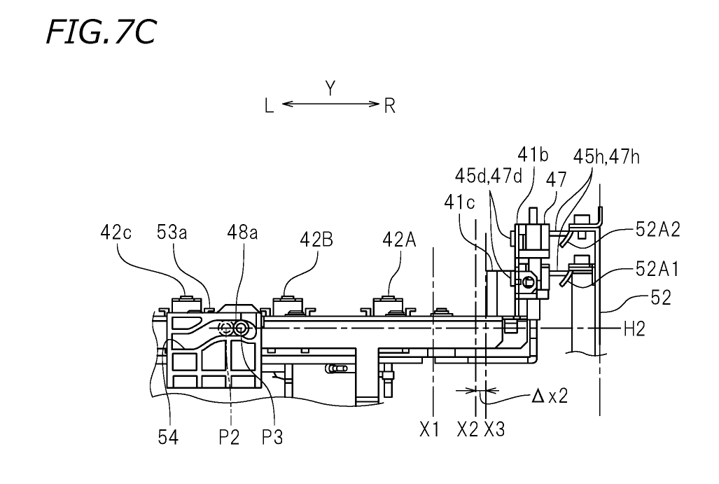

As illustrated in FIG. 5, the four composite cap valves 47 are disposed on the right surface of the table wall 41b. Each cap valve 45 is disposed such that the front of each cap valve 45 faces in the rightward direction R. The rods 45h and 47h are disposed such that the rods 45h and 47h protrude in the rightward direction R. The table wall 41b is provided with through holes at locations where the cap valves 45 are to be attached to the table wall 41b. The outlets 45d and 47d of the cap valves 45 are inserted into the through holes of the table wall 41b (see FIGS. 7A to 7C). As illustrated in FIG. 12, two of the four composite cap valves 47 are disposed on a relatively upper portion of the table wall 41b and in alignment with each other in the front-rear direction X. The other two of the four composite cap valves 47 are disposed on a relatively lower portion of the table wall 41b and in alignment with each other in the front-rear direction X. The two composite cap valves 47 on the upper side U are deviated from the other two composite cap valves 47 on the lower side D in the front-rear direction X by one-half of the dimension of the first cap valve area A or the second cap valve area B in the front-rear direction X. Thus, the inlets 45c and 47c of the two composite cap valves 47 on the upper side U are inserted into the through holes 47k of the two composite cap valves 47 on the lower side D. Although not illustrated in detail, the opening/closing passages 44a connected to the inlets 45c and 47c of the two composite cap valves 47 on the upper side U are also inserted into the through holes 47k of the two composite cap valves 47 on the lower side D. The dimension of each of the inlets 45c and 47c in the plan view (e.g., the outer diameter of each of the inlets 45c and 47c) is smaller than the dimension of each through hole 47k in the plan view (e.g., the inner diameter of each through hole 47k). The dimension of each through hole 47k in the plan view is larger than the dimension of each of the inlets 45c and 47c in the plan view. Thus, the four composite cap valves 47 are arranged in a “hound's tooth pattern”. As used herein, the term “hound's tooth pattern” refers to a pattern in which the composite cap valves 47 are disposed in a staggered configuration. Accordingly, the term “hound's tooth pattern” may refer to a gingham check pattern, a zigzag arrangement, a staggered arrangement, and other similar arrangements and patterns.

Each opening/closing passage 44a connected to the associated cap 42 extends in the rightward direction R from a location below the movable table 41. First ends of the opening/closing passages 44a are connected to an associated pair of the caps 42. Second ends of the opening/closing passages 44a are connected to the inlets 45c and 47c of the associated composite cap valve 47. As illustrated in FIGS. 11A and 11B, the inlets 45c and 47c disposed on the lower ends of the cap valves 45 function as downstream connections connected to the associated opening/closing passages 44a. The inlets 45c and 47c of each composite cap valve 47 are connected, through the associated opening/closing passages 44a, for example, to an associated pair of the caps 42 adjacent to each other.

Each suction pump 46 includes an inlet on the upstream side, and an outlet on the downstream side. Each suction pump 46 sucks, through the inlet, a fluid (e.g., gas such as air or liquid such as ink) in a portion of the associated suction passage 44b connected to the upstream inlet of the suction pump 46, and sends the fluid to the outlet. This reduces the pressure inside the portion of the associated suction passage 44b connected to the upstream inlet of the suction pump 46. Thus, with each cap 42 attached to the associated ink head 32, driving each suction pump 46 reduces the pressure inside the associated enclosed space S and sucks the fluid inside the associated enclosed space S. Each suction pump 46 sends the sucked fluid to a downstream portion of the associated suction passage 44b. Each suction pump 46 is not limited to any particular configuration. In one example, each suction pump 46 is a cylinder type suction pump. Each suction pump 46 is an example of a suction device. The waste liquid bottle 49 is a container to contain liquid (such as ink) discharged to the downstream side from each suction pump 46. The waste liquid bottle 49 may be attachable to and detachable from the lower portion of the side cover 15, for example.

As illustrated in FIG. 2, the guide device 50 defines a path along which the movable table 41 is movable. The guide device 50 includes a base 51, a right side wall 52, a guide wall 53, and a spring 55.

The base 51 defines and functions as a base for an entirety of the guide device 50. The right side wall 52 stands vertically or substantially vertically in the up-down direction Z on an end of the base 51 facing in the rightward direction R. The upper end of the right side wall 52 includes lifters 52A each extending obliquely downward to the left. In other words, each lifter 52A includes an inclined surface extending obliquely upward to the right. Each lifter 52A is a member to lift the rod 45h or 47h of the associated cap valve 45. Each lifter 52A is an example of a valve opener. Each lifter 52A is provided by sheet metal processing. In one example, each lifter 52A is provided by bending the upper end of the right side wall 52.

In the present preferred embodiment, each lifter 52A is disposed on the left surface of the right side wall 52 such that each lifter 52A faces the rod 45h or 47h of the associated cap valve 45. Because the four composite cap valves 47 are disposed in a hound's tooth pattern, the rods 45h and 47h are also disposed in a hound's tooth pattern. Thus, the lifters 52A according to the present preferred embodiment are also disposed in a hound's tooth pattern. Specifically, the right side wall 52 includes a first right side wall 52d and a second right side wall 52u. With the composite cap valves 47 in the closed state, the first right side wall 52d is located below the rods 45h and 47h of the two composite cap valves 47 disposed on the relatively lower portion of the table wall 41b. With the composite cap valves 47 in the closed state, the second right side wall 52u is located above the rods 45h and 47h of the two composite cap valves 47 disposed on the relatively lower portion of the table wall 41b.

The first right side wall 52d is made of a sheet of steel connected to the base 51. The lifters 52A include first lifters 52A1. The first lifters 52A1 are provided on the upper end of the first right side wall 52d by sheet metal processing. Specifically, the first lifters 52A1 are provided by bending the upper end of the first right side wall 52d such that the first lifters 52A1 extend toward the composite cap valves 47 (i.e., substantially in the leftward direction L). Each first lifter 52A1 is provided on a portion of the first right side wall 52d that faces the rod 45h or 47h, but no lifter 52A1 is provided on a portion of the first right side wall 52d that does not face the rod 45h or 47h. Whether a portion of the first right side wall 52d faces the rod 45h or 47h does not necessarily have to be determined based on whether the portion of the first right side wall 52d faces the rod 45h or 47h in the main scanning direction Y in a strict sense. For example, suppose that distances are measured between each rod 45h or 47h and points on an imaginary line extending in the front-rear direction X on the first right side wall 52d (which may be the second side wall 52u) at a height at which the first right side wall 52d faces the rods 45h and 47h. In this case, the present preferred embodiment involves defining, in accordance with the distances measured, first points Q1 each located closest to the associated rod 45h or 47h and second points Q2 each located farthest away from the associated rod 45h or 47h. An intermediate point Qm is located between each first point Q1 and the associated second point Q2. Thus, a portion of the first right side wall 52d located closer to the first point Q1 relative to the intermediate point Qm may be determined as a “portion of the first right side wall 52d that faces the rod 45h or 47h”, and a portion of the first right side wall 52d located closer to the second point Q2 relative to the intermediate point Qm may be determined as a “portion of the first right side wall 52d that does not face the rod 45h or 47h”. Accordingly, the first right side wall 52d has a saw-toothed shape having projections and recesses arranged alternately in the plan view, with the first lifters 52A1 defining the projections.

The second right side wall 52u made of a sheet of steel is connected to the upper portion of the first right side wall 52d. A portion of the first right side wall 52d and a portion of the second right side wall 52u are flush or substantially flush with each other in the up-down direction Z. The lifters 52A include second lifters 52A2. The second lifters 52A2 are provided on the upper end of the second right side wall 52u by sheet metal processing. Specifically, the second lifters 52A2 are provided by bending the upper end of the second right side wall 52u such that the second lifters 52A2 extend toward the composite cap valves 47 (i.e., substantially in the leftward direction L). Each second lifter 52A2 is provided on a portion of the second right side wall 52u that faces the rod 45h or 47h, but no second lifter 52A2 is provided on a portion of the second right side wall 52u that does not face the rod 45h or 47h. A portion of the second right side wall 52u that faces the rod 45h or 47h and a portion of the second right side wall 52u that does not face the rod 45h or 47h may be determined in a manner similar to that used for the first right side wall 52d. Accordingly, the second right side wall 52u has a saw-toothed shape having projections and recesses arranged alternately in the plan view, with the second lifters 52A2 defining the projections.

As previously described, the rods 45h and 47h are arranged in a hound's tooth pattern. Thus, the first and second lifters 52A1 and 52A2 are also arranged in a hound's tooth pattern. In one example, the first and second lifters 52A1 and 52A2 are arranged such that each first lifter 52A1 is located between the second lifters 52A2 in the plan view. In the plan view, the rods 45h and 47h of the two composite cap valves 47 disposed on the relatively lower portion of the table wall 41b are each located between the second lifters 52A2 protruding from the right side wall 52.

The guide wall 53 stands vertically or substantially vertically on the base 51 and extends in the main scanning direction Y. The guide wall 53 includes: a guide wall 53a disposed on the front portion of the base 51; a guide wall 53b disposed on the front portion of the base 51; a guide wall 53c disposed on the rear portion of the base 51; and a guide wall 53d disposed on the rear portion of the base 51. The guide walls 53a and 53c face each other in the front-rear direction X on the base 51. The guide walls 53b and 53d face each other in the front-rear direction X on the base 51. The four guide walls 53a, 53b, 53c, and 53d are identical or substantially identical in shape. The four guide walls 53a, 53b, 53c, and 53d are provided with guide holes 54. As illustrated in FIGS. 7A to 7C, each guide hole 54 is an elongated hole that extends obliquely upward from a lower left position P1 to an upper right position P2 and then extends in the rightward direction R from the position P2 to a position P3. The position P1 is located at a height H1. The positions P2 and P3 are each located at a height H2. The height H2 is higher than the height H1 by a distance Δh. The positions P1 and P2 have a distance Δx1 therebetween in the right-left direction Y. The positions P2 and P3 have a distance Δx2 therebetween in the right-left direction Y. The guide pins 48a, 48b, 48c, and 48d of the movable table 41 of the cap unit 40 are respectively inserted into the guide holes 54 of the guide walls 53a, 53b, 53c, and 53d. Thus, the movable table 41 is supported by the guide wall 53. The movable table 41 is movable between the guide wall 53a and the guide wall 53c and between the guide wall 53b and the guide wall 53d in the main scanning direction Y within a range in which the guide pins 48a, 48b, 48c, and 48d are movable along the guide holes 54. The guide holes 54 define a path along which the movable table 41 is movable.

The spring 55 is connected to the upper surface of the base 51 and the lower surface of the movable table 41. The connection between the spring 55 and the movable table 41 is located obliquely above and rightward of the connection between the spring 55 and the base 51. In one example, a helical tension spring is usable as the spring 55. The spring 55 is connected, under predetermined tension, to the base 51 and the movable table 41. The spring 55 urges the movable table 41 downward to the left at all times.

The guide device 50 moves the movable table 41 in conjunction with movement of the ink head unit 30. In other words, the guide device 50 moves the cap unit 40 in conjunction with movement of the ink heads 32. The guide device 50 defines a path along which the cap unit 40 is movable between a retracted position (which will be described below), a cap attaching position (which will be described below), and a valve opening position (which will be described below).

As illustrated in FIG. 7A, the movable table 41 is supported by the guide device 50 such that the guide pins 48a, 48b, 48c, and 48d are each located at the position P1 at normal times owing to the tension of the spring 55. In this state, the cap unit 40 is located at the “retracted position”. In one example, the cap unit 40 is located at the retracted position during printing effected by the printer 1. With the cap unit 40 located at the retracted position, the upper ends of the caps 42A to 42H are located below the lower ends of the ink heads 32A to 32H, and the left lateral surface of the stopper 41c of the movable table 41 is located at a first location X1.

Once the printer 1 has stopped printing, the ink head unit 30 is held in the side cover 15. After printing, the carriage on which the ink head unit 30 is mounted is moved in the rightward direction R. The right lateral surface of the engagement portion 31A (see FIG. 2) is the foremost portion of the carriage 31 in the direction of travel during the movement of the carriage 31 in the rightward direction R. As used herein, the term “position of the carriage 31” refers to the position of the right lateral surface of the engagement portion 31A of the carriage 31. The carriage 31 abuts, at the first location X1, against the stopper 41c of the movable table 41 located at the retracted position. As used herein, the term “first location X1” refers to the position of the carriage 31 corresponding to the retracted position of the cap unit 40. Further movement of the carriage 31 to a position rightward of the first location X1 causes the engagement portion 31A of the carriage 31 to press the stopper 41c of the movable table 41 farther rightward. Thus, the movable table 41 moves together with the carriage 31 in the rightward direction R against the tension of the spring 55.

The carriage 31 moves the ink head unit 30 to the “cap attaching position” so as to attach the caps 42A to 42H to the ink heads 32A to 32H, respectively. As illustrated in FIG. 7B, the position of the carriage 31 corresponding to the “cap attaching position” is a second location X2. The engagement portion 31A of the carriage 31 moves the stopper 41c of the movable table 41 in the rightward direction R by the distance Δx1. As a result of this movement, the left lateral surface of the stopper 41c of the movable table 41 is also located at the second location X2. The movement of the movable table 41 in the rightward direction R is restricted by the guide holes 54. The movement of the movable table 41 in the rightward direction R by the distance Δx1 causes each of the guide pins 48a, 48b, 48c, and 48d to move from the position P1 and the position P2. In accordance with the movement of the movable table 41 in the rightward direction R by the distance Δx1, the movable table 41 moves in the upward direction U by the distance Δh. The movement of the movable table 41 just described causes the caps 42A to 42H secured to the movable table 41 to be respectively attached to the ink heads 32A to 32H. In other words, moving the carriage 31 from the first location X1 to the second location X2 causes the cap unit 40 to move from the “retracted position” to the “cap attaching position”. Consequently, the caps 42A to 42H are respectively attached to the ink heads 32A to 32H.

As illustrated in FIG. 7C, the carriage 31 is allowed to move to the “valve opening position” located in the rightward direction R relative to the “cap attaching position”. The “valve opening position” is located in the rightward direction R relative to the “cap attaching position” by the distance Δx2. During movement of the carriage 31 from the “cap attaching position” to the “valve opening position”, the engagement portion 31A of the carriage 31 presses the stopper 41c of the movable table 41 at the cap attaching position farther rightward. This moves the movable table 41 in the rightward direction R by the distance Δx2 against the tension of the spring 55. The guide pins 48a, 48b, 48c, and 48d each move from the position P2 to the position P3. Because the position P2 and the position P3 are located at the same height, the ink heads 32A to 32H and the caps 42A to 42H move in the rightward direction R, with the caps 42A to 42H kept attached to the ink heads 32A to 32H. As a result of the movement of the carriage 31 to the “valve opening position”, the left lateral surface of the stopper 41c of the movable table 41 is located at a third location X3. The movement of the carriage 31 to the “valve opening position” just described first causes the rods 45h and 47h of the composite cap valves 47, disposed on the right surface of the table wall 41b of the movable table 41, to abut against the lifters 52A of the right side wall 52 of the guide device 50. More specifically, the rods 45h and 47h of the two composite cap valves 47, disposed on the relatively lower portion of the table wall 41b, abut against the first lifters 52A1, and the rods 45h and 47h of the two composite cap valves 47, disposed on the relatively upper portion of the table wall 41b, abut against the second lifters 52A2. An end of each of the rods 45h and 47h facing in the first direction Y1 includes an oblique surface extending obliquely upward to the right. An end of each of the first and second lifters 52A1 and 52A2 facing in the second direction Y2 includes an oblique surface extending obliquely upward to the right. Thus, the rods 45h and 47h and the first and second lifters 52A1 and 52A2 provide a sliding mechanism through which the rods 45h and 47h abut against the first and second lifters 52A1 and 52A2 so as to convert movement of the rods 45h and 47h in the right-left direction Y into movement of the rods 45h and 47h in the up-down direction Z. Accordingly, further movement of the movable table 41 in the first direction Y1 causes the rods 45h and 47h to move upward along the inclined surfaces of the first and second lifters 52A1 and 52A2, so that the rods 45h and 47h are lifted in the upward direction U. As a result, the two cap valves 45 included in each composite cap valve 47 are switched from the closed state to the open state. In other words, the movement of the carriage 31 to the “valve opening position” enables the cap valves 45 to switch to the open state, with the caps 42A to 42H respectively attached to the ink heads 32A to 32H. The rods 45h and 47h included in the four composite cap valves 47 simultaneously abut against the first and second lifters 52A1 and 52A2, so that all of the rods 45h and 47h are simultaneously lifted in the upward direction U. Consequently, the eight cap valves 45 are simultaneously switched to the open state.

Movement of the carriage 31 in the leftward direction L toward a position leftward of the “valve opening position” or the “cap attaching position” causes the engagement portion 31A of the carriage 31 to stop applying a pressing force to the stopper 41c of the movable table 41 or reduce the pressing force applied to the stopper 41c. The movable table 41 is urged downward to the left by the spring 55. Thus, the movable table 41 is moved to the “retracted position” from the “valve opening position” or the “cap attaching position”.

The controller 100 is configured or programmed to comprehensively control operations of the components of the printer 1. The controller 100 is not limited to any particular configuration. In one example, the controller 100 is a microcomputer. The microcomputer is not limited to any particular hardware configuration. In one example, the microcomputer includes: an interface (I/F) to transmit and receive information, such as print data, to and from an external device, such as a host computer; a central processing unit (CPU) to execute commands included in a printing control program; a read-only memory (ROM) storing programs to be executed by the CPU; a random-access memory (RAM) to be used as a working area where the programs are to be expanded; and a memory storing various data, such as the printing control program. The controller 100 may include a rewritable programmable logic device, such as a field-programmable gate array (FPGA). In one example, the FPGA may include a CPU core provided by an integrated circuit, a multiplier, a RAM, and related peripheral circuitry.

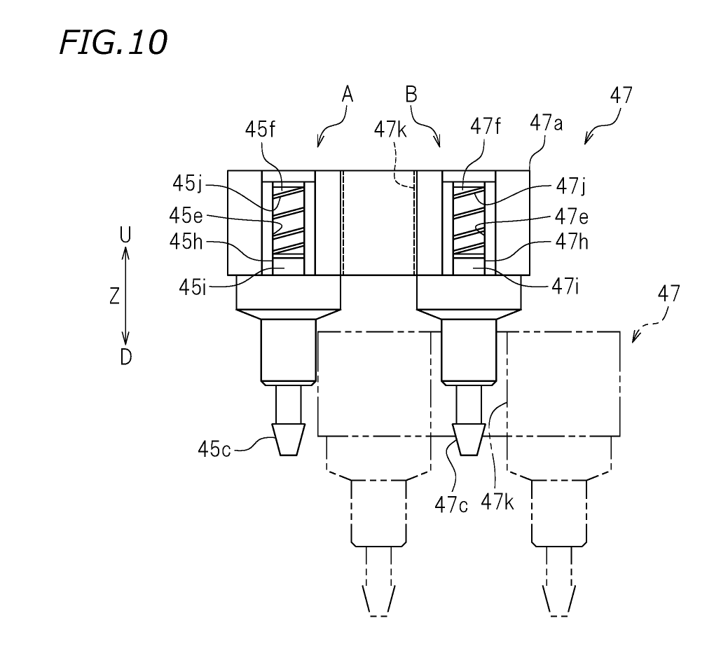

FIG. 8 is a block diagram of the controller 100. The controller 100 is configured or programmed to include a first controller 101, a second controller 102, and a third controller 103. The controller 100 additionally includes a fourth controller 104, a fifth controller 105, a sixth controller 106, and a printing controller 107. The first to sixth controllers 101 to 106 control suction cleaning for the ink heads 32, which is to be performed by the cap unit 40. The first to sixth controllers 101 to 106 cause the printer 1 to perform suction cleaning for the ink heads 32 by following the procedure illustrated in FIG. 9, for example. The printing controller 107 controls basic printing operations to be performed by the printer 1. The functions of each of the controllers of the controller 100 may be implemented by hardware (e.g., a circuit) or may be implemented by executing a computer program by the CPU.

The printing controller 107 is electrically connected to the ink heads 32, the feed motor, and the scan motor. In accordance with the printing control program and the print data stored in the memory, the printing controller 107 causes the scan motor to move the carriage 31 in the main scanning direction Y at a predetermined speed. The printing controller 107 then causes the ink heads 32 mounted on the carriage 31 to discharge ink from predetermined positions based on the print data. This operation and movement of the recording medium 8 in the sub-scanning direction X caused by the feed motor are repeatedly carried out in an alternating manner. Thus, the printer 1 effects printing in accordance with the print data.

The first controller 101 performs capping (S1 in FIG. 9). The first controller 101 is electrically connected to the scan motor to move the ink heads 32. When the printer 1 has stopped printing, the first controller 101 actuates the scan motor so as to move the carriage 31 from the first location X1 to the second location X2 in the rightward direction R. Thus, the carriage 31 causes the cap unit 40 at the retracted position to move to the cap attaching position along the path defined by the guide device 50. As a result, the caps 42 are attached to the ink heads 32. The enclosed space S is defined between each cap 42 and the associated ink head 32.

The second controller 102 switches the cap valves 45 to the open state. The second controller 102 is electrically connected to the scan motor. The second controller 102 actuates the scan motor so as to move the carriage 31 from the second location X2 to the third location X3 in the rightward direction R. This causes the cap unit 40 and the ink head unit 30 located at the cap attaching position to move to the valve opening position, with the caps 42 kept attached to the ink heads 32. As a result of this movement, the rods 45h and 47h of the cap valves 45 abut against the lifters 52A of the guide device 50, and the rods 45h and 47h are lifted in the upward direction U so as to switch the cap valves 45 to the open state. The movement of the carriage 31 just described causes all of the composite cap valves 47 to simultaneously switch to the open state. Thus, the enclosed space S defined between each cap 42 and the associated ink head 32 is exposed to external atmospheric pressure, with the caps 42 kept attached to the ink heads 32.

The third controller 103 performs de-capping (S5 in FIG. 9) involving detaching the caps 42 from the ink heads 32. The third controller 103 is electrically connected to the scan motor. The third controller 103 actuates the scan motor so as to move the carriage 31 from the third location X3 to the second location X2 and then from the second location X2 to the first location X1 in the leftward direction L. This enables the ink head unit 30 to move from the third location X3 to the second location X2 and then from the second location X2 to the first location X1. In the present preferred embodiment, the movable table 41 is urged downward to the left by the spring 55. In accordance with the movement of the carriage 31 from the third location X3 to the second location X2, the cap unit 40 is moved from the valve opening position to the cap attaching position, with the caps 42 kept attached to the ink heads 32. Concurrently with the movement of the cap unit 40, the rods 45h and 47h of the cap valves 45 move away from the lifters 52A of the guide device 50 in the leftward direction L, so that the rods 45h and 47h are lowered in the downward direction D owing to gravity. Thus, the cap valves 45 are switched from the open state to the closed state. In accordance with the movement of the carriage 31 from the second location X2 to the first location X1, the cap unit 40 located at the cap attaching position is moved to the first location X1 corresponding to the retracted position. The ink head unit 30 located at the cap attaching position is moved to the retracted position along the path defined by the guide device 50. Consequently, the cap unit 40 and the ink head unit 30 move away from each other in the up-down direction Z while moving in the leftward direction L, so that the caps 42 are detached from the ink heads 32. The third controller 103 may actuate the scan motor so as to move the carriage 31 to a position leftward of the first location X1. In one example, the position leftward of the first location X1 may be a home position.

The fourth controller 104 performs main suction (S2 in FIG. 9). The fourth controller 104 is electrically connected to the suction pumps 46. After the caps 42 are attached to the ink heads 32 by the first controller 101, the fourth controller 104 drives the suction pumps 46. This reduces the pressure inside each enclosed space S. In one example, the fourth controller 104 reduces the pressure inside each enclosed space S such that the pressure inside each enclosed space S is in the range of about −20 kPa to about −35 kPa. The fourth controller 104 may reduce the pressure inside each enclosed space S to about −30 kPa, for example. In one example, the fourth controller 104 drives the suction pumps 46 at a flow velocity between about 3 cc/sec and about 10 cc/sec inclusive. The fourth controller 104 may drive the suction pumps 46 at a flow velocity of about 7.3 cc/sec, for example. The flow velocity may vary depending on the capacity of each cap 42. In one example, the time required for such pressure reduction is about 10 seconds to about 20 seconds. The time required for such pressure reduction may be about 13.7 seconds, for example. Thus, ink remaining in the nozzles 33 of the ink heads 32 is dischargeable to the caps 42 and the passages 44. The ink discharged to the caps 42 and the passages 44 from the ink heads 32 is collectable into the waste liquid bottle 49. The fourth controller 104 may deactivate the suction pumps 46 upon lapse of the pressure reduction time mentioned above, for example, after the activation of the suction pumps 46. Deactivating the suction pumps 46 by the fourth controller 104 ends main suction in suction cleaning.

The fifth controller 105 makes a pressure equalizing adjustment (S3 in FIG. 9). After the suction pumps 46 are deactivated by the fourth controller 104, the fifth controller 105 maintains the depressurized state brought about by the deactivation of the suction pumps 46. With the caps 42 kept attached to the ink heads 32, the fifth controller 105 maintains the deactivated state of the suction pumps 46 for a predetermined period of time. In one example, the depressurized state is maintained by the fifth controller 105 for about 3 seconds to about 10 seconds, for example. The depressurized state may be maintained by the fifth controller 105 for about 5 seconds, for example. Thus, the depressurized state of the ink heads 32, portions of the passages upstream of the ink heads 32, and the enclosed spaces S is maintained such that the pressures inside the ink heads 32, the pressures inside the portions of the passages upstream of the ink heads 32, and the pressures inside the enclosed spaces S are equalized.

The sixth controller 106 performs idle suction (S4 in FIG. 9). The sixth controller 106 is electrically connected to the suction pumps 46. After the cap valves 45 are switched to the open state by the second controller 102, the sixth controller 106 drives the suction pumps 46. With the caps 42 kept attached to the ink heads 32, the sixth controller 106 causes each suction pump 46 to exert idle suction on the space defined between the associated ink head 32 and the associated cap 42 and exposed to atmospheric pressure. During idle suction, the sixth controller 106 drives the suction pumps 46 so as to reduce the pressure in the portions of the suction passages 44b upstream of the suction pumps 46. In one example, the sixth controller 106 causes each suction pump 46 to suck the fluid in a portion of the associated suction passage 44b upstream of the suction pump 46 and discharge the fluid to a portion of the associated suction passage 44b downstream of the suction pump 46 (or external atmosphere) at a transfer rate higher than that for main suction. The transfer rate may vary depending on the capacity of each cap 42. In one example, the sixth controller 106 drives the suction pumps 46 at a flow velocity between about 40 cc/sec and about 80 cc/sec inclusive. The sixth controller 106 may drive the suction pumps 46 at a flow velocity of about 65.6 cc/sec, for example. In one example, the time required for such pressure reduction is about 1 second to about 10 seconds. The time required for such pressure reduction may be about 5 seconds, for example. The sixth controller 106 may cause the suction pumps 46 to exert suction simultaneously with the movement of the carriage 31 effected by the second controller 102, or may drive the suction pumps 46 after the movement of the carriage 31 to the valve opening position. Thus, ink remaining in the opening/closing passages 44a, the enclosed spaces S, the caps 42, and the suction passages 44b is discharged downstream of the suction pumps 46. The ink discharged is collectable into the waste liquid bottle 49. The sixth controller 106 ends idle suction by deactivating the suction pumps 46.

In the present preferred embodiment, the first controller 101 moves the carriage 31 from the first location X1 to the second location X2, and the second controller 102 moves the carriage 31 from the second location X2 to the third location X3. This enables the enclosed space S defined between each ink head 32 and the associated cap 42 to be exposed to external atmospheric pressure, with the caps 42 kept attached to the ink heads 32. The third controller 103 moves the carriage 31 from the third location X3 to the second location X2, so that the space defined between each ink head 32 and the associated cap 42 and exposed to external atmospheric pressure is enclosed so as to define the enclosed space S between each ink head 32 and the associated cap 42 again. In other words, the present preferred embodiment enables the cap valves 45 to switch between the open state and the closed state with the use of the scan motor. This makes it unnecessary to provide any new member. Consequently, the present preferred embodiment enables, with an uncomplicated structure, exposure of the inside of the caps 42 to atmospheric pressure in a simple manner, with the caps 42 kept attached to the ink heads 32.

In the present preferred embodiment, the third controller 103 moves the carriage 31 from the second location X2 to the first location X1 so as to detach the caps 42 from the ink heads 32. In other words, a simple operation involving driving the scan motor enables detachment of the caps 42 from the ink heads 32 and opening and closing of the cap valves 45 in a simple and smooth manner. This makes it possible to easily and smoothly perform, for example, suction cleaning for the ink heads 32.

In the present preferred embodiment, the first to sixth controllers 101 to 106 operate in conjunction with each other so as to suitably perform suction cleaning illustrated in FIG. 9. Specifically, as indicated by Table 1 below, the first controller 101 drives the scan motor so as to perform capping (S1), the fourth controller 104 drives the suction pumps 46 so as to perform main suction (S2), the fifth controller 105 maintains the depressurized state for a predetermined period of time so as to make a pressure equalizing adjustment (S3), the sixth controller 106 drives the suction pumps 46 so as to perform idle suction (S4), and then the third controller 103 drives the scan motor so as to perform de-capping (S5). Performing steps S1 to S5 in this manner makes it possible to suitably carry out suction cleaning.

TABLE 1

| | STEP | | | | |
|---|---|---|---|---|---|
| | | | S3 | | |
| | | | Pressure | | |
| | S1 | S2 | Equalizing | S4 | S5 |
| | Capping | Main Suction | Adjustment | Idle Suction | De-Capping |
| CONTROLLER | First | — | — | Second | Third |
| | Controller | | | Controller | Controller |
| CARRIAGE | X1 → X2 | X2 | X2 | X2 → X3 | X3 → X1 |
| POSITION | | | | | |
| MOVABLE | Retracted | Cap Attaching | Cap Attaching | Cap Attaching | Valve Opening |
| TABLE | Position → | Position | Position | Position → | Position → |
| POSITION | Cap Attaching | | | Valve Opening | Retracted |
| | Position | | | Position | Position |
| CAP | Attached | Attached | Attached | Attached | Detached |
| CAP VALVE | Closed | Closed | Closed | Open | Closed |
| CONTROLLER | — | Fourth | Fifth | Sixth | — |
| | | Controller | Controller | Controller | |
| PUMP | Deactivated | Activated | Deactivated | Activated | Deactivated |

Suction cleaning known in the art may induce entrance of air into an ink head that has undergone cleaning or may cause backflow of ink to an ink head that has undergone cleaning. Entrance of air into an ink head makes it necessary to remove air using a damper provided for the ink head. Backflow of ink makes it necessary to clean an ink chamber in the ink head. Paragraph of JP 2016-87858 A discloses an operation that involves, when an enclosed space is exposed to atmospheric pressure, continuing suction exerted by a suction pump. Specifically, this operation involves driving the suction pump from start of main suction to end of idle suction. This operation prevents or reduces entrance of air into an ink head and backflow of ink but may apply an excessive negative pressure to the ink head. Application of an excessive negative pressure to an ink head is unfavorable because it may cause variations in meniscus conditions for nozzles. The inventors of preferred embodiments of the present invention have discovered that a phenomenon such as entrance of air into an ink head after cleaning or backflow of ink to an ink head after cleaning occurs for the reasons below. To prevent ink from dripping from nozzles of an ink head, a negative pressure of as low as about −1 kPa, for example, is usually applied to the inside of an ink passage in the ink head. The nozzles (i.e., discharge holes) of the ink head are very small in cross-sectional area. The length of the ink passage in the ink head is sufficiently large as compared to its cross-sectional area. Thus, depressurizing an enclosed space during main suction takes a relatively long time in order to reduce the pressure of the entire ink passage in the ink head. Accordingly, suction cleaning known in the art may cause a difference between the pressure inside the enclosed space and the pressure inside the ink head (in particular, the pressure of a portion of the ink passage upstream of the enclosed space) after main suction. Exposing the enclosed space to external atmospheric pressure for idle suction exerts a force to suck a fluid (e.g., air or ink) from the enclosed space to the ink head, resulting in backflow of the fluid. For example, if ink that has been discharged as a result of main suction is stored in large amount in a cap, the enclosed space may be exposed to external atmospheric pressure, with the discharged ink adhering to the surface of the ink head. This unfavorably causes the discharged ink adhering to the surface of the ink head to flow back to the ink head.

In contrast to the conventional technique described above, the present preferred embodiment involves making a pressure equalizing adjustment after main suction during suction cleaning for the ink heads 32. The enclosed space S defined between each ink head 32 and the associated cap 42 is relatively large. This makes it easy to depressurize the enclosed spaces S when the ink heads 32 are depressurized by main suction. Spaces in the nozzles 33 of the ink heads 32 are sufficiently small in cross-sectional area and large in length. This makes it difficult to depressurize the spaces in the nozzles 33 when the ink heads 32 are depressurized by main suction. Thus, pressure differences are likely to occur between the nozzles 33 and the enclosed spaces S after main suction. In one example, main suction may result in a situation where the enclosed spaces S are depressurized to about −30 kPa but the spaces in the nozzles 33 of the ink heads 32 are depressurized to about −10 kPa, for example. Regions adjacent to boundaries between the nozzles 33 and the enclosed spaces S receive a force that will further reduce the pressure inside the nozzles 33. Exposing the enclosed spaces S to external atmospheric pressure for idle suction without making a pressure equalizing adjustment unfavorably causes the fluid (e.g., air or ink) in the enclosed spaces S to flow into the nozzles 33 owing to the force that will further reduce the pressure inside the nozzles 33. Suppose that as illustrated in FIG. 3, for example, the ink heads 32A and 32B are each provided with the first and second nozzle rows 33a and 33b to discharge different colors of ink. In this case, two different colors of ink may adhere to the nozzle surfaces 33D of the ink heads 32A and 32B during main suction, so that each of the two different colors of ink may solely flow into the nozzles 33 or a mixture of the two different colors of ink may flow into the nozzles 33, resulting in contamination of the nozzles 33. The printer 1 according to the present preferred embodiment, however, enters a suspended state where the printer 1 is on standby, with its system kept in the closed state, from end of main suction to start of idle suction. Making such a pressure equalizing adjustment reduces pressure differences between the nozzles 33 and the enclosed spaces S. Consequently, the present preferred embodiment prevents the fluid (e.g., air or ink) from flowing into the nozzles 33 during idle suction.

In the present preferred embodiment, each cap 42 has a box shape having a recess recessed downward from the upper surface of the cap 42. The first passages and the second passages each include a cap-side end disposed in an associated one of the caps 42. The cap-side end of each second passage is in communication with the recess of the associated cap 42 through the bottom of the body case 43a. The cap-side end of each first passage is disposed at least partially above the cap-side end of each second passage in the recess of the associated cap 42. In other words, the cap-side end of each first passage to be exposed to atmospheric pressure is disposed at least partially above the cap-side end of each second passage through which ink remaining in the associated cap 42 is to be sucked. Thus, with the caps 42 attached to the ink heads 32, the atmosphere is introduced into the upper region of each cap 42 through the associated first passage. This makes it possible to suitably and efficiently suck ink stored in each cap 42 through the associated second passage.

In the present preferred embodiment, each cap 42 includes the groove 43e recessed downward from the upper surface of the bottom of the lip 43d. The cap-side end of each second passage is in communication with the recess of the lip 43d through the groove 43e. This makes it possible to more efficiently suck, along the groove 43e, ink stored in each cap 42. Because the groove 43e extends across substantially the entire upper surface of the bottom of the lip 43d, the present preferred embodiment enables idle suction that uniformly sucks ink from substantially the entire upper surface of the bottom of the lip 43d along the groove 43e instead of locally sucking ink through the through hole 43c. Consequently, the present preferred embodiment reduces the amount of ink remaining in the caps 42.

In the present preferred embodiment, each cap valve 45 includes an intra-valve passage, a piston valve element to close the intra-valve passage, and a spring defining or functioning an elastic member to urge the piston valve element to a closing position. Each cap valve 45 is structured such that movement of the piston valve element against the elastic force of the elastic member in accordance with a command from the second controller 102 switches the cap valve 45 to the open state. Such a configuration eliminates the need for any special power source to return the piston valve element to the closing position. This enables opening and closing of the cap valves 45 in a simple manner. Such a configuration is particularly suitable for the printer 1 that includes a large number of ink heads 32. In one example, the number of ink heads 32 is four or more. The number of ink heads 32 is preferably six or more, for example. The number of ink heads 32 is more preferably eight or more, for example.

In the present preferred embodiment, the printer 1 includes the carriage 31 movable in the main scanning direction Y. The ink heads 32 are mounted on the carriage 31. The guide device 50 defines and functions as a movable table conveyor to move the movable table 41 provided with the caps 42. The guide device 50 includes: the guide pins 48a, 48b, 48c, and 48d; at least one pair of guide walls; and guide holes 54. The guide pins 48a, 48b, 48c, and 48d each protrude from the movable table 41 in a direction intersecting the main scanning direction Y. The guide walls stand vertically or substantially vertically and extend in the main scanning direction Y. The movable table 41 is disposed between the guide walls. Each guide hole 54 extends in the main scanning direction Y such that a portion of each guide hole 54 extends obliquely upward. The guide device 50 moves the movable table 41 at least in the up-down direction Z so as to move the caps 42 between the cap attaching position and the retracted position. If the ink heads 32 are increased in number, such a configuration would make it possible to easily provide the cap unit 40 that includes the caps 42 having a number that corresponds to the number of ink heads 32 without taking up much space.

Although the preferred embodiments of the present invention have been described thus far, the foregoing preferred embodiments are only illustrative and the present invention may be embodied in various other forms.

In the foregoing preferred embodiments, the fifth controller 105 maintains the depressurized state for a predetermined period of time, for example. The printer 1 according to the present preferred embodiment, however, may maintain the depressurized state in any other suitable manner. The dampers 26aa, 26ab, 26ba, and 26bb of the printer 1 respectively include the sensors 27aa, 27ab, 27ba, and 27bb each that detect the pressure of ink in the associated storage chamber. The dampers 26aa, 26ab, 26ba, and 26bb are disposed immediately upstream of the ink heads 32. The pressure detected by each of the sensors 27aa, 27ab, 27ba, and 27bb is equal or substantially equal to the pressure inside the nozzles 33 of the associated ink head 32. Thus, upon determining that the pressure inside the nozzles 33 detected by the sensors 27aa, 27ab, 27ba, and 27bb is equal or substantially equal to the pressure inside the enclosed spaces S, the controller 100 may end the deactivated state of the suction pumps 46 maintained by the fifth controller 105, so as to allow the second controller 102 to control the cap valves 45 and allow the sixth controller 106 to control the suction pumps 46. In one example, the pressure inside the nozzles 33 may be determined to be equal to the pressure inside the enclosed spaces S when T1×0.8≤T2≤T1, where T1 denotes a suction pressure applied to each enclosed space S by main suction, and T2 denotes the pressure inside the nozzles 33. Consequently, the present preferred embodiment more reliably prevents a fluid (e.g., ink or air) from flowing into the ink heads 32 during idle suction.

In the foregoing preferred embodiments, the cap valves 45 are structured such that movement of the movable table 41 in the main scanning direction Y causes the rods 45h and 47h to move in the up-down direction Z along the lifters 52A so as to move the piston valve elements 45f and 47f in the up-down direction Z. The piston valve elements 45f and 47f of the cap valves 45, however, may be moved in any other suitable manner. The piston valve elements 45f and 47f may be movable in the main scanning direction Y, for example. In one example, the piston valve elements 45f and 47f may be respectively urged rightward by the springs 45j and 47j at all times such that the cap valves 45 are in the closed state. In such an example, movement of the movable table 41 in the rightward direction R may press the rods 45h and 47h against, for example, the right side wall 52. This may move the piston valve elements 45f and 47f in the leftward direction L inside the composite valve case 47a against the elastic forces of the springs 45j and 47j so as to switch the cap valves 45 to the open state. Alternatively, the piston valve elements 45f and 47f may move in any other suitable direction(s) other than the up-down direction Z and the main scanning direction Y so as to switch the cap valves 45 between the open state and the closed state.

In the foregoing preferred embodiments, each first passage is connected to the protrusive hole 43b protruding from the lower surface of the associated cap 42. Each first passage, however, may be connected to the associated cap 42 in any other manner. In one example, each first passage may be connected to a through hole (not illustrated) provided in an upper portion of the side wall of the body case 43a of the associated cap 42, such that the first passage is in communication with the enclosed space S at a location above the absorber 43h. Such a configuration also achieves effects similar to those described above.

In the foregoing preferred embodiments, the guide device 50 moves the movable table 41 in the main scanning direction Y and the up-down direction Z. The guide device 50, however, may move the movable table 41 in any suitable direction(s). In one example, the guide device 50 may move the movable table 41 only in the up-down direction Z. In another example, the guide device 50 may move the movable table 41 in the main scanning direction Y, the up-down direction Z, and the sub-scanning direction X.

The printer 1 may include a cleaner (not illustrated) to wipe the nozzle surfaces 33D of the ink heads 32 and/or clean a member used to wipe the nozzle surfaces 33D. The cleaner may be disposed inside the side cover 15 and leftward of the cap unit 40 such that the cleaner is located side by side with the cap unit 40. Thus, the cleaner performs additional cleaning after suction cleaning. Specifically, the cleaner wipes the nozzle surfaces 33D of the ink heads 32 that have undergone suction cleaning.

In the foregoing preferred embodiments, the printer 1 includes the platen 6, on which the recording medium 8 is to be placed, such that the recording medium 8 is conveyed in the sub-scanning direction X by the grit rollers 16. The printer 1, however, is not limited to such a configuration. In one example, the printer 1 may be a “flatbed printer”. The printer 1 may include a table to move the recording medium 8 in the main scanning direction Y and the sub-scanning direction X.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer comprising:
an ink head including a nozzle surface provided with a nozzle to discharge ink;
an ink head conveyor to move the ink head in a main scanning direction, the main scanning direction including a first direction and a second direction opposite to the first direction;
a movable table including a cap attachable to the ink head so as to cover the nozzle surface, the movable table being movable in the main scanning direction by the ink head conveyor;
a cap valve connected to the cap through a first passage to open and close the first passage;
a valve opener to open the cap valve;
a guide defining a path along which the movable table is movable between a cap attaching position, a valve opening position, and a retracted position, the cap attaching position being a position where the cap is attached to the ink head, the valve opening position being located in the first direction relative to the cap attaching position, the valve opening position being a position where the cap valve abuts against the valve opener, the retracted position being located in the second direction relative to the cap attaching position, the retracted position being a position where the cap is detached from the ink head; and
a controller configured or programmed such that:
movement of the movable table to the valve opening position causes the valve opener to abut against the cap valve so as to bring the cap valve to an open state and expose the first passage to atmosphere; and
movement of the movable table to the cap attaching position from the valve opening position causes the valve opener to move away from the cap valve so as to bring the cap valve to a closed state.

2. The inkjet printer according to claim 1, wherein
the valve opener is disposed on the guide; and
when the movable table is located at the valve opening position, the valve opener is located in the first direction relative to the movable table.

3. The inkjet printer according to claim 1, wherein
the cap valve is disposed on the movable table;
the cap valve includes:
a valve to open and close the first passage, and
a switch to switch the valve between an opening position and a closing position; and
when the movable table is located at the valve opening position, the switch abuts against the valve opener so as to bring the cap valve to the open state.

4. The inkjet printer according to claim 1, wherein
the movable table includes a contact that is in engagement with the ink head conveyor when the ink head conveyor is located at a first location, a second location, a third location, and any locations between the first, second and third locations, the first location corresponding to the retracted position, the second location corresponding to the cap attaching position, the third location corresponding to the valve opening position;
the movable table is movable such that during movement of the ink head conveyor in the first direction from the first location, the contact in the first direction together with the ink head conveyor;
the cap valve includes a piston valve that is dynamically changeable between a closing position where inside of the first passage is out of communication with outside of the first passage and an opening position where the inside of the first passage is in communication with the outside of the first passage;
the valve opener is structured to contact the cap valve to enable the piston valve to dynamically change from the closing position to the opening position; and
the controller includes:
a first controller configured or programmed to move the ink head conveyor from the first location to the second location in the first direction so as to attach the cap to the ink head;
a second controller configured or programmed to move the ink head conveyor from the second location to the third location in the first direction so as to switch the cap valve from the closed state to the open state; and
a third controller configured or programmed to move the ink head conveyor to the first location in the second direction so as to detach the cap from the ink head.

5. The inkjet printer according to claim 4, further comprising a suction pump connected to the cap through a second passage; wherein
the controller further includes:
a fourth controller configured or programmed to, after the cap is attached to the ink head by the first controller, drive the suction pump so as to depressurize an enclosed space defined between the nozzle surface and the cap; and
a fifth controller configured or programmed to, after the enclosed space is depressurized by the fourth controller, maintain a predetermined depressurized state.

6. The inkjet printer according to claim 4, further comprising a suction pump connected to the cap through a second passage, wherein
the controller further includes a sixth controller configured or programmed to, after the cap valve is switched to the open state by the second controller, drive the suction pump so as to exert idle suction on a space defined between the nozzle surface and the cap.

7. The inkjet printer according to claim 5, wherein
the cap includes a bottom and a side wall extending upward from the bottom, the cap having a box shape including a recess defined by the bottom and the side wall;
the first passage and the second passage each include a cap-side end disposed in the cap;
the cap-side end of the second passage is in communication with the recess through the bottom; and
the cap-side end of the first passage is disposed at least partially above the cap-side end of the second passage in the recess.

8. The inkjet printer according to claim 7, wherein
the bottom of the cap includes a groove recessed downward; and
the cap-side end of the second passage is in communication with the recess through the groove.

9. The inkjet printer according to claim 1, wherein the cap valve includes:
an intra-valve passage;
a piston valve to close the intra-valve passage; and
an elastic force applicator to urge the piston valve to a closing position; and
the movement of the movable table to the valve opening position causes the piston valve urged to the closing position to come into contact with the valve opener so as to change the piston valve to the opening position against an elastic force of the elastic force applicator.

10. The inkjet printer according to claim 5, further comprising a sensor to detect a pressure inside the nozzle, wherein
the fifth controller is configured or programmed to maintain the predetermined depressurized state until the fifth controller determines that the pressure inside the nozzle detected by the sensor is equal to a pressure inside the enclosed space.

11. The inkjet printer according to claim 1, wherein
the movable table includes a guide pin protruding in a direction intersecting the main scanning direction;
the guide includes:
at least one pair of guide walls standing vertically or substantially vertically and extending in the main scanning direction, the guide walls being disposed such that the movable table is located between the guide walls in a direction intersecting the main scanning direction; and
a guide hole disposed in at least one of the guide walls, the guide hole receiving the guide pin therethrough; and the guide hole includes:
a first portion extending obliquely upward in the first direction to guide movement of the movable table between the retracted position and the cap attaching position; and
a second portion extending in the main scanning direction to guide movement of the movable table between the cap attaching position and the valve opening position.
